(19) United States
(12) Patent Application Publication
(10) Pub. No.: US 2026/0169197 A1
(43) Pub. Date: Jun. 18, 2026

(54) LAMINATE, ANTIREFLECTION FILM, POLARIZING PLATE, AND DISPLAY DEVICE

(71) Applicant: FUJIFILM Corporation, Tokyo (JP)

(72) Inventor: Kunihiro ATSUMI, Minamiashigara-shi (JP)

(73) Assignee: FUJIFILM Corporation, Tokyo (JP)

(21) Appl. No.: 19/529,205

(22) Filed: Feb. 4, 2026

Related U.S. Application Data
(63) Continuation of application No. PCT/JP2024/034805, filed on Sep. 27, 2024.

(30) Foreign Application Priority Data
Sep. 29, 2023 (JP) 2023-170300

(51) Int. Cl. G02B 1/111; G02B 5/30

(52) U.S. Cl. CPC G02B 1/111; G02B 5/3016

(57) ABSTRACT

Provided are a laminate including a liquid crystal layer A containing a coloring agent and a liquid crystal layer B disposed adjacent to the liquid crystal layer A, in which an extraordinary refractive index ne(A) of the liquid crystal layer A and an extraordinary refractive index ne(B) of the liquid crystal layer B satisfy Expression (1), an antireflection film or a polarizing plate including the laminate, and a display device including any one of the laminate, the antireflection film, or the polarizing plate.

$$ne ( A ) > neg ( B ) . \qquad Expression ( 1 )$$

### CROSS-REFERENCE TO RELATED APPLICATIONS

This application is a Continuation of PCT International Application No. PCT/JP2024/034805 filed on Sep. 27, 2024, which claims priority under 35 U.S.C. § 119(a) to Japanese Patent Application No. 2023-170300 filed in Japan on Sep. 29, 2023. Each of the above applications is hereby expressly incorporated by reference, in its entirety, into the present application.

### BACKGROUND OF THE INVENTION

### 1. Field of the Invention

The present invention relates to a laminate, an antireflection film, a polarizing plate, and a display device.

### 2. Description of the Related Art

An organic electroluminescent (OLED) display device is a device that displays an image by utilizing self-luminescence of an OLED element. Therefore, the OLED display device has advantages that a high contrast ratio, a high color reproducibility, a wide viewing angle, high-speed responsiveness, and a reduction in thickness and weight can be achieved, as compared with various display devices such as a liquid crystal display device and a plasma display device. In addition to these advantages, in terms of flexibility, research and development are being actively carried out as a next-generation display device.

Various developments have been made for a film applied to a surface of the display device, and for example, as described in JP2021-120746A and the like, a technology of absorbing light from an oblique direction by providing a vertically aligned coloring agent film in which dichroic coloring agents are vertically aligned is known. According to this technology, in the display device, in a case of being visually recognized from a normal direction (hereinafter, also referred to as a “front direction”) with respect to a light emitting surface, the coloring agent in the vertically aligned coloring agent film does not absorb light and exhibits a high transmittance, whereas in a case of being visually recognized from an oblique direction (that is, a direction tilted by a predetermined angle from the normal direction, hereinafter, also referred to as an “oblique direction”) with respect to the light emitting surface, the coloring agent in the vertically aligned coloring agent film absorbs light. Since the external light reflection is mainly derived from the oblique direction, the function of suppressing the external light reflection can be exhibited by applying this technology.

### SUMMARY OF THE INVENTION

On the other hand, in a case where the vertically aligned coloring agent film in which the dichroic coloring agents are vertically aligned, which is described in JP2021-120746A and the like, is bonded to a substrate such as a surface film by an adhesive layer exhibiting optical isotropy, in the external light reflection at the interface between the vertically aligned coloring agent film and the adhesive layer, the interface reflection in the front direction can be suppressed by index matching, but it is difficult to perform index matching for the interface reflection in the oblique direction, and a problem of an increase in the interface reflection occurs. In addition, in a case where a horizontally aligned coloring agent film in which the dichroic coloring agents are horizontally aligned, a liquid crystal film containing a coloring agent that does not exhibit dichroism, or the like is bonded to the substrate, the same problem of the interface reflection in the oblique direction as in the vertically aligned coloring agent film occurs.

Therefore, an object of the present invention is to provide a laminate including a liquid crystal layer containing a coloring agent, in which interface reflection in both the front direction and the oblique direction can be effectively suppressed in a state of being bonded to a substrate, an antireflection film or a polarizing plate including the laminate, and a display device including any one of the laminate, the antireflection film, or the polarizing plate.

As a result of intensive studies in view of the above-described object, the present inventor has found that by providing a liquid crystal layer having a lower extraordinary refractive index ne than the liquid crystal layer on a surface of the liquid crystal layer containing a coloring agent as an index matching layer (IM layer), the refractive index difference in the oblique direction can be reduced in a state of being bonded to an adherend via the IM layer, and thus the interface reflection in the oblique direction can also be suppressed. Further studies have been carried out based on these findings, whereby the present invention has been completed.

That is, the above object has been achieved by the following aspects.
<1>
A laminate comprising:
a liquid crystal layer A containing a coloring agent; and
a liquid crystal layer B disposed adjacent to the liquid crystal layer A,
in which an extraordinary refractive index ne(A) of the liquid crystal layer A and an extraordinary refractive index ne(B) of the liquid crystal layer B satisfy Expression (1),

$$ne ( A ) > ne ( B ) . \qquad Expression ( 1 )$$

<2>
The laminate according to claim 1,
in which the coloring agent is a dichroic coloring agent.
<3>
The laminate according to <1> or <2>, further comprising:
an adhesive layer on a side of the liquid crystal layer B opposite to a side in contact with the liquid crystal layer A,
in which ne(B) and a refractive index n(C) of the adhesive layer satisfy Expression (2),

$$ne ( B ) > n ( C ) . \qquad Expression ( 2 )$$

<4>
The laminate according to any one of <1> to <3>,
in which alignment directions of the liquid crystal layer A and the liquid crystal layer B are each in vertical alignment.
<5>
The laminate according to any one of <1> to <3>,
in which alignment directions of the liquid crystal layer A and the liquid crystal layer B are each in horizontal alignment.
<6>
An antireflection film comprising:
the laminate according to <4>.
<7>
A polarizing plate comprising:
the laminate according to <5>.
<8>
A display device comprising:
the laminate according to any one of <1> to <5>, the antireflection film according to <6>, or the polarizing plate according to <7>.

In the present invention, unless otherwise specified, components contained in each layer (the liquid crystal layer A and the liquid crystal layer B, and an adhesive layer C which may be provided) constituting the laminate and each component in a composition used for forming each layer may be contained in each layer constituting the laminate in one kind or two or more kinds.

In addition, in the present invention, the numerical value range indicated by using “to” means a range including the numerical values before and after “to” as the lower limit value and the upper limit value, respectively.

In the present invention, the “composition” includes a mixture in which the component concentration varies within a range in which a desired function is not impaired, in addition to a mixture in which the component concentration is constant (respective components are uniformly dispersed).

In the present invention, angles (for example, angles such as “90°”) and relationships (for example, “vertical”, “horizontal”, “front”, “oblique”, and the like) include a range of errors allowed in the technical field to which the present invention belongs. For example, the allowable error range means a range of strict angle±10°, and the difference between the strict angle and the error angle is preferably 5° or less, and more preferably 3° or less.

In the present invention, the extraordinary refractive index ne and the ordinary light refractive index no in the liquid crystal layer A and the liquid crystal layer B are values at 550 nm at 25° C., which are measured using a spectroscopic ellipsometer such as M-2000U or RC2 manufactured by J. A. Woollam Co., Ltd. or SE-2000 manufactured by Semilab, Inc. (all of which are trade names). Details thereof will be described in Examples later.

In addition, in the present invention, the refractive index n of the adhesive layer is a value at 589 nm at 25° C., which is measured using an Abbe refractometer such as NAR-4T (trade name, manufactured by Atago Co., Ltd.).

In the present invention, an alignment degree S(A) of the liquid crystal layer A is a value measured and calculated from an angle dependence of an absorbance. In a case where the liquid crystal layer A is vertically aligned, the alignment degree S(A) is a value measured and calculated by measuring a Mueller matrix using a Mueller matrix measurement device such as AxoScan (trade name, manufactured by Axometrics, Inc.). In a case where the liquid crystal layer A is horizontally aligned, the alignment degree S(A) is a value measured and calculated by measuring the absorbance using an optical microscope such as ECLIPSE E600 POL (trade name, manufactured by Nikon Corporation) and a multi-channel spectrometer such as QE65000 (trade name, manufactured by Ocean Optics, Inc.). Details thereof will be described in Examples later.

In addition, in the present invention, an alignment degree S(B) of the liquid crystal layer B is a value measured and calculated by Raman spectroscopic measurement using a micro-Raman spectroscopic analysis device such as nanofinder30 (trade name, manufactured by Tokyo Instruments Co., Ltd.). Details thereof will be described in Examples later.

In the present invention, in a case where there are a plurality of substituents, linking groups, and the like (hereinafter, referred to as substituents and the like) represented by specific reference numerals or formulae, or in a case where a plurality of substituents and the like are defined at the same time, the respective substituents and the like may be the same as or different from each other unless otherwise specified. The same applies to the definition of the number of substituents or the like. In addition, in a case where a plurality of substituents and the like come close to each other (particularly in a case where the substituents and the like are adjacent to each other), the substituents and the like may also be linked to each other to form a ring unless otherwise specified. In addition, unless otherwise specified, rings, for example, alicyclic rings, aromatic rings, and heterocyclic rings may be further fused to form a fused ring.

In the present invention, in a case where an E type double bond and a Z type double bond are present in a molecule, the double bond may be any one thereof or may be a mixture thereof, unless otherwise specified.

In the present invention, the representation of a compound (including a complex) is used to have a meaning including not only the compound itself but also a salt thereof, and an ion thereof. In addition, it is meant to include those in which a part of the structure is changed within a range where the effect of the present invention is not impaired. Furthermore, it is meant that a compound, which is not specified to be substituted or unsubstituted, may have any substituent within a range where the effect of the present invention is not impaired. The same applies to the definition of a substituent or a linking group.

In the present invention, in a case where the number of carbon atoms in a certain group is defined, the number of carbon atoms means the total number of carbon atoms in the group unless otherwise specified. That is, in a case where this group has a form that further has a substituent, it means the total number of carbon atoms, to which the number of carbon atoms of this substituent is included.

The laminate according to the embodiment of the present invention includes a liquid crystal layer containing a coloring agent, and can effectively suppress interface reflection in both the front direction and the oblique direction in a state of being bonded to a substrate.

In addition, the antireflection film, the polarizing plate, and the display device according to the embodiment of the present invention include the laminate according to the embodiment of the present invention, and can suppress interface reflection in both the front direction and the oblique direction.

### BRIEF DESCRIPTION OF THE DRAWINGS

FIG. 1 is a schematic longitudinal cross-sectional view showing a configuration of an embodiment of a display device according to the present invention. Hatching showing a cross section is omitted.

FIG. 2 is a schematic longitudinal cross-sectional view showing a configuration of another embodiment of the display device according to the present invention. Hatching showing a cross section is omitted.

### DESCRIPTION OF THE PREFERRED EMBODIMENTS

### <Laminate>

A laminate according to the embodiment of the present invention is a laminate including: a liquid crystal layer A containing a coloring agent; and a liquid crystal layer B disposed adjacent to the liquid crystal layer A, in which an extraordinary refractive index ne(A) of the liquid crystal layer A and an extraordinary refractive index ne(B) of the liquid crystal layer B satisfy Expression (1).

$$ne ( A ) > ne ( B ) . \qquad Expression ( 1 )$$

In the laminate according to the embodiment of the present invention, the liquid crystal layer B having an extraordinary refractive index ne(B) smaller than the extraordinary refractive index ne(A) of the liquid crystal layer A containing a coloring agent (hereinafter, also simply referred to as a “liquid crystal layer A”) is disposed adjacent to the liquid crystal layer A. Therefore, in a case where the liquid crystal layer A is bonded to a film such as a surface film, a difference in refractive index as viewed from the oblique direction between the liquid crystal layer A and an adhesive layer (hereinafter, also referred to as an “adhesive layer C”) having a refractive index n(C) generally smaller than ne(A) of the liquid crystal layer A can be suppressed to be small by the extraordinary refractive index ne(B) of the liquid crystal layer B, and the interface reflection from the oblique direction can be suppressed.

In the present invention, the term “disposed adjacent to” means that the layers are directly in contact with each other. That is, in the laminate according to the embodiment of the present invention, the liquid crystal layer A containing a coloring agent and the liquid crystal layer B are laminated in a state of being directly in contact with each other without an interposed bonding layer or the like described later.

From the viewpoint of further suppressing the interface reflection in the oblique direction, in the laminate according to the embodiment of the present invention, it is preferable that the liquid crystal layer B has the adhesive layer C on a side opposite to a side in contact with the liquid crystal layer A, and the extraordinary refractive index ne(B) of the liquid crystal layer B and a refractive index n(C) of the adhesive layer C satisfy Expression (2).

$$ne ( B ) > n ( C ) . \qquad Expression ( 2 )$$

A difference (ne(A)−ne(B)) between ne(A) and ne(B) in Expression (1) and a difference (ne(B)−n(C)) between ne(B) and n(C) in Expression (2) are preferably 0.15 or less and more preferably 0.10 or less. Among these, both the difference between ne(A) and ne(B) in Expression (1) and the difference between ne(B) and n(C) in Expression (2) are preferably 0.15 or less and more preferably 0.10 or less.

In the laminate according to the embodiment of the present invention, the ordinary refractive index no(A) of the liquid crystal layer A and the refractive index n(C) of the adhesive layer C are preferably values within a range of no(B)±0.10 and more preferably values within a range of no(B)±0.05 with respect to the ordinary refractive index no(B) of the liquid crystal layer B.

In addition, it is also preferable that Expression (4A) or (4B) is satisfied.

$$no ( A ) \leq no ( B ) \leq n ( C ) \qquad Expression ( 4 A )$$

$$no ( A ) \geq no ( B \geq n ( C ) ) \qquad Expression ( 4 B )$$

In the laminate according to the embodiment of the present invention, in a case where Expression (1) is satisfied and the ordinary refractive index no(B) of the liquid crystal layer B and the refractive index n(C) of the adhesive layer C satisfy the above-described preferable relationship (relationship in which no(A) and n(C) are values within a range of no(B)±0.10 (more preferably, no(B)±0.05) or the relationship in addition to the relationship, the relationship represented by Expression (4A) or (4B)), the interface reflection in the front direction can be further suppressed, and the suppression of the interface reflection in the oblique direction by the relationship of Expression (1) can be more effectively exhibited.

Hereinafter, the liquid crystal layer A and the liquid crystal layer B constituting the laminate according to the embodiment of the present invention, the adhesive layer C, the substrate, the surface film, and the like that may be included in the laminate according to the embodiment of the present invention will be described in detail in addition to the configurations specified above.

### [Liquid Crystal Layer A]

The liquid crystal layer A is a liquid crystal layer containing a coloring agent, and is formed of a composition containing a coloring agent and a liquid crystal compound as described later.

The coloring agent contained in the liquid crystal layer A is not particularly limited, and a commonly used coloring agent can be applied. Among these, in a case of the dichroic coloring agent described later, the liquid crystal layer A can be imparted with a light absorption characteristic according to an alignment direction of the liquid crystal constituting the liquid crystal layer A, and the laminate according to the embodiment of the present invention can be used as a laminate having a specific function such as the antireflection film and the polarizing plate described later, which is preferable.

It is preferable that the liquid crystal layer A has an absorption axis in the thickness direction. Here, the term “having an absorption axis in the thickness direction” means that the absorbance in the thickness direction is higher than the absorbance in any direction other than the thickness direction.

In addition, it is preferable that the absorption axis of the liquid crystal layer A is substantially parallel to the thickness direction. In other words, it is preferable that the absorption axis of the liquid crystal layer A is vertically aligned with respect to a surface (main surface) of the liquid crystal layer A.

Here, the term “substantially parallel to the thickness direction” means that an angle between the absorption axis and the thickness direction is 0° to 10°.

In order for the liquid crystal layer A to have an absorption axis in the thickness direction, a method of vertically aligning the dichroic coloring agent can be used. In other words, a method of aligning the dichroic coloring agent such that a major axis direction of the dichroic coloring agent is substantially parallel to the thickness direction of the liquid crystal layer A can be used. The definition of the substantially parallel is as described above.

It is also preferable that the liquid crystal layer A has an absorption axis in the in-plane direction. Here, the term “having an absorption axis in the in-plane direction” means that the absorbance in the in-plane direction (absorbance in any direction in the plane, which exhibits a maximum value) is higher than the absorbance in any direction other than the in-plane direction.

In addition, it is preferable that the absorption axis of the liquid crystal layer A is substantially parallel to the in-plane direction. In other words, it is preferable that the absorption axis of the liquid crystal layer A is horizontally aligned with respect to a surface (main surface) of the liquid crystal layer A.

Here, the term “substantially parallel to the in-plane direction” means that an angle between the absorption axis and the in-plane direction (surface (main surface) of the liquid crystal layer A) is 0° to 10°.

In order for the liquid crystal layer A to have an absorption axis in the in-plane direction, a method of horizontally aligning the dichroic coloring agent can be used. In other words, a method of aligning the dichroic coloring agent such that a major axis direction of the dichroic coloring agent is substantially parallel to the in-plane direction of the liquid crystal layer A can be used. The definition of the substantially parallel is as described above.

The components contained in the composition containing a coloring agent and a liquid crystal compound, which is used for forming the liquid crystal layer A, will be described below.

### (Coloring Agent)

The coloring agent is not particularly limited, and a commonly used coloring agent can be applied. Among these, a dichroic coloring agent having a property that an absorbance in a major axis direction of a molecule and an absorbance in a minor axis direction of the molecule are different is preferable.

From the molecular shape, examples of the dichroic coloring agent include a rod-like dichroic coloring agent and a disk-like dichroic coloring agent, and a rod-like dichroic coloring agent is preferable.

The maximal absorption wavelength of the dichroic coloring agent is not particularly limited, and can be appropriately selected depending on the use form of the laminate according to the embodiment of the present invention.

Examples of the dichroic coloring agent include acridine coloring agents, oxazine coloring agents, cyanine coloring agents, naphthalene coloring agents, azo coloring agents, and anthraquinone coloring agents, and azo coloring agents are preferable. Examples of the azo coloring agent include monoazo coloring agents, bisazo coloring agents, trisazo coloring agents, tetrakisazo coloring agents, and stilbeneazo coloring agents, and bisazo coloring agents or trisazo coloring agents are preferable. Compounds described in JP2018-53167A are also preferable.

It is preferable that the dichroic coloring agent has a polymerizable group. By having the polymerizable group, even in a case where the amount of the dichroic coloring agent used is large, the crosslinking degree of the liquid crystal layer A is not reduced, and a liquid crystal layer A having a thin thickness and high selective wavelength absorptivity and excellent in durability can be formed.

Examples of the polymerizable group include polymerizable groups having an ethylenically unsaturated bond, such as a vinyl group, a vinyloxy group, a styryl group, a p-(2-phenylethenyl)phenyl group, an acryloyl group, a methacryloyl group, an acryloyloxy group, and a methacryloyloxy group, an epoxy group, and an oxetanyl group.

It is preferable that the dichroic coloring agent has an aromatic ring. Examples of the aromatic ring include aromatic hydrocarbon rings and aromatic heterocyclic rings. Among these, aromatic hydrocarbon rings are preferable, and a benzene ring is more preferable.

The azo coloring agent is preferably a compound represented by Formula (10).

$${{A}^{1} ( - N = N - {A}^{2} )}_{p} - N = N - {A}^{3} \qquad Formula ( 10 )$$

In Formula (10), A¹ and A³ each independently represent a phenyl group optionally having a substituent, a naphthyl group optionally having a substituent, or a monovalent heterocyclic group optionally having a substituent. A² represents a 1,4-phenylene group optionally having a substituent, a naphthalene-1,4-diyl group optionally having a substituent, or a divalent heterocyclic group optionally having a substituent. p represents an integer of 1 to 4. In a case where p is an integer of 2 or more, a plurality of A²'s may be the same or different.

Examples of the monovalent heterocyclic group include groups obtained by removing one hydrogen atom from a heterocyclic compound such as quinoline, thiazole, benzothiazole, thienothiazole, imidazole, benzimidazole, oxazole, and benzoxazole.

Examples of the divalent heterocyclic group include groups obtained by removing two hydrogen atoms from the above heterocyclic compound.

Examples of the optional substituent of a phenyl group, a naphthyl group, and a monovalent heterocyclic group of A¹ and A³, and a 1,4-phenylene group, a naphthalene-1,4-diyl group, and a divalent heterocyclic group of A² include an alkyl group having 1 to 4 carbon atoms such as a methyl group, an ethyl group, and a butyl group; an alkoxy group having 1 to 20 carbon atoms such as a methoxy group, an ethoxy group, and a butoxy group; a fluorinated alkyl group having 1 to 4 carbon atoms such as a trifluoromethyl group; a cyano group; a nitro group; a hydroxyl group; a halogen atom such as a chlorine atom and a fluorine atom; and a substituted or unsubstituted amino group such as an amino group, a diethylamino group, and a pyrrolidino group (the substituted amino group means an amino group having one or two alkyl groups having 1 to 6 carbon atoms, or an amino group in which two substituted alkyl groups are bonded to each other to form an alkanediyl group having 2 to 8 carbon atoms. The unsubstituted amino group is —NH_{2.}).

Examples of the alkyl group having 1 to 6 carbon atoms include a methyl group, an ethyl group, and a hexyl group. Examples of the alkanediyl group having 2 to 8 carbon atoms include an ethylene group, a propane-1,3-diyl group, a butane-1,3-diyl group, a butane-1,4-diyl group, a pentane-1,5-diyl group, a hexane-1,6-diyl group, a heptane-1,7-diyl group, and an octane-1,8-diyl group.

The substituent of a phenyl group, a naphthyl group, and a monovalent heterocyclic group of A¹ and A³ is preferably a substituent containing a polymerizable group.

The substituent containing a polymerizable group is preferably a group represented by Formula (11)

$$P - {Sp}^{1} - {( {L}^{1} - {A}^{1} )}_{n} - {L}^{2} - * \qquad Formula ( 11 )$$

P represents a polymerizable group. The definition of the polymerizable group is as described above.

Sp¹ represents an alkylene group having 2 to 16 carbon atoms, and non-adjacent —CH₂-groups in the alkylene group may be substituted with —CO— or —O—.
L¹ and L² each independently represent a single bond, —O—, —OCO—, —COO—, or —OCOO—.

A¹ represents a 1,4-phenylene group, a 1,3-phenylene group, a 1,4-naphthylene group, or a 1,5-naphthylene group optionally having a substituent.

n is an integer of 0 to 3.

Specific examples of the dichroic coloring agent include dichroic substances described in paragraphs 0038 and 0039 of JP7013577B.

A content of the coloring agent in the composition is preferably 70 to 130 parts by mass and more preferably 80 to 120 parts by mass with respect to 100 parts by mass of the liquid crystal compound described later in the composition.

The coloring agent may be used alone or in combination of two or more. In a case where two or more kinds of coloring agents are used, a total amount of these coloring agents is preferably in the above-described range.

### (Liquid Crystal Compound)

The liquid crystalline compound preferably has a polymerizable group. That is, the composition preferably contains a polymerizable liquid crystal compound. The definition of the polymerizable group is as described in the section of the dichroic coloring agent.

The liquid crystal compound preferably has an aromatic ring. Examples of the aromatic ring include aromatic hydrocarbon rings and aromatic heterocyclic rings. Among these, aromatic hydrocarbon rings are preferable, and a benzene ring is more preferable.

Examples of the polymerizable liquid crystal compound include low-molecular-weight liquid crystal compounds having a polymerizable group and polymer liquid crystal compounds having a polymerizable group.

Here, the “low-molecular-weight liquid crystalline compound” means a liquid crystal compound having no repeating unit in a chemical structure thereof. In addition, the term “high-molecular-weight liquid crystal compound” means a liquid crystal compound having a repeating unit in a chemical structure, and may be a homopolymer or a copolymer. Among the high-molecular-weight liquid crystal compounds, the copolymer having a repeating unit may be any polymer such as a random polymer, a block polymer, a graft polymer, or a star polymer.

Examples of the low-molecular-weight liquid crystal compound include polymerizable liquid crystal compounds described in paragraphs 0072 to 0088 of JP2013-228706A and low-molecular-weight liquid crystal compounds among liquid crystal compounds described in paragraphs [0019] to [0140] of WO2022/014340A, the descriptions of which are incorporated herein by reference. Among these, a smectic liquid crystal compound is preferable.

Examples of the high-molecular-weight liquid crystal compound include thermotropic liquid crystal polymers described in JP2011-237513A, high-molecular-weight liquid crystal compounds described in paragraphs [0012] to [0042] of WO2018/199096A, and high-molecular-weight liquid crystal compounds among liquid crystal compounds described in paragraphs [0019] to [0140] of WO2022/014340A, the descriptions of which are incorporated herein by reference.

The content of the liquid crystal compound in the composition is preferably 10 to 20 mass %, and more preferably 12 to 18 mass % with respect to the total solid content in the composition.

The liquid crystal compound may be used alone, in combination of two or more kinds thereof, or in combination of a low-molecular-weight liquid crystal compound and a high-molecular-weight liquid crystal compound. In a case where two or more liquid crystal compounds are used, the total amount thereof is preferably within the above range.

The solid content means the components excluding the solvent in the composition. Even in a case where the components are liquids, these are calculated as solids.

The composition may contain components other than the coloring agent and the liquid crystal compound.

### (Vertical Alignment Agent)

In a case of forming the vertically aligned liquid crystal layer A, it is preferable that the composition contains a vertical alignment agent. In a case where the composition contains a vertical alignment agent, the dichroic coloring agent and the liquid crystal compound can be more vertically aligned, and the degree of alignment order can be increased.

Examples of the vertical alignment agent include a boronic acid compound and an onium salt.

The boronic acid compound is preferably a compound represented by Formula (30).

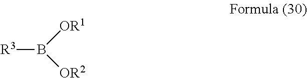

In Formula (30), R¹ and R² each independently represent a hydrogen atom, a substituted or unsubstituted aliphatic hydrocarbon group, a substituted or unsubstituted aryl group, or a substituted or unsubstituted heterocyclic group.

R³ represents a substituent containing a (meth)acrylic group.

Specific examples of the boronic acid compound include boronic acid compounds represented by General Formula (I) described in paragraphs 0023 to 0032 of JP2008-225281A and boronic acid compounds described in paragraph 0076 of JP7013577B.

Examples of the onium salt include onium salts described in paragraphs 0024 to 0055 of JP2008-026730A, the description of which is incorporated herein by reference. Among these, a quaternary ammonium salt represented by General Formula (I) described in paragraph 0027 of JP2008-026730A is preferable.

A content of the vertical alignment agent in the composition is preferably 0.1 to 400 parts by mass and more preferably 0.5 to 350 parts by mass with respect to 100 parts by mass of the liquid crystal compound.

The vertical alignment agents may be used alone or in combination of two or more kinds thereof. In a case where two or more kinds of vertical alignment agents are used, the total amount thereof is preferably within the above range.

### (Cleavage-Type Surfactant Polymer)

It is preferable that the composition contains a cleavage-type surfactant polymer.

The cleavage-type surfactant polymer is a polymer having a repeating unit including a cleavage group which is decomposed by the action of at least one of light, heat, acid, or base to generate a polar group (hereinafter, also referred to as a “repeating unit including a cleavage group”), and means a polymer in which a surface (interface) of the liquid crystal layer is activated by the generated polar group. In a case where the composition contains the cleavage-type surfactant polymer, the surface roughness of the liquid crystal layer A caused by drying wind is suppressed, the dichroic coloring agent is more uniformly aligned, and the laminate according to the embodiment of the present invention, in which a liquid crystal layer B that is vertically or horizontally aligned is laminated directly on the liquid crystal layer A without an interposed photo-alignment film, can be obtained.

For example, in a case where the cleavage-type surfactant polymer has a repeating unit including a cleavage group which is decomposed by the action of acid to generate a polar group, the cleavage-type surfactant polymer unevenly distributed on the coating film surface of the liquid crystal layer A generates acid from a photoacid generator by being irradiated with light (ultraviolet rays) after the coating film is cured, and the cleavage-type surfactant polymer is cracked and eliminated by the acid generated in the elimination part. As a result, the surface energy of the liquid crystal layer A (cured film) is increased, and the coating properties of the composition for forming the vertically or horizontally aligned liquid crystal layer B are improved. Further, the hydroxy group or the ketone group present in the part of the cleavage-type surfactant polymer where the elimination part is eliminated and the vertical alignment agent contained in the composition for forming the vertically aligned liquid crystal layer B chemically act on each other, whereby the cleavage-type surfactant polymer also functions as a vertical alignment film for the liquid crystal layer B. In addition, the cleavage-type surfactant polymer also functions as a horizontal alignment film for the liquid crystal layer B by the polarized light irradiation. As a result, the laminate according to the embodiment of the present invention, in which a liquid crystal layer B that is vertically or horizontally aligned is laminated directly on the liquid crystal layer A without an interposed bonding layer, photo-alignment film, or the like described later, can be obtained.

The cleavage-type surfactant polymer may contain other repeating units such as a repeating unit including a photo-alignment group, in addition to the repeating unit including a cleavage group which is decomposed by the action of at least one of light, heat, acid, or base to generate a polar group. In a case where the cleavage-type surfactant polymer is a copolymer, the cleavage-type surfactant polymer may be any polymer such as a random polymer, a block polymer, a graft polymer, or a star polymer, and a random polymer or a block polymer is preferable.

Hereinafter, each repeating unit will be described in detail.

### (Repeating Unit Containing Cleavage Group)

As the repeating unit including a cleavage group, which is contained in the cleavage-type surfactant polymer, a repeating unit having a cleavage group which is decomposed by the action of at least one of light, heat, acid, or base to generate a polar group in a side chain and having a fluorine atom or a silicon atom at a terminal more than the cleavage group in the side chain is preferable, and a repeating unit having a fluorine atom at a terminal more than the cleavage group in the side chain is more preferable. Examples of the repeating unit including a cleavage group, which has a polar group and is obtained by decomposing the cleavage group by the action of at least one of light, heat, acid, or base, include “repeating unit including hydroxyl group” and “repeating unit including ketone group” described in paragraphs 0048 to 0059 of WO2021/166619A, the description of which is incorporated herein by reference.

Examples of the repeating unit including a cleavage group include “repeating unit A including a cleavage group which is decomposed by the action of at least one selected from the group consisting of light, heat, acid, and base to generate a polar group” described in paragraphs 0014 to 0049 of WO2018/216812A, the description of which is incorporated herein by reference. Specific examples thereof include repeating units described in paragraphs 0037 and 0038 of WO2018/216812A.

In addition, as such a repeating unit, a repeating unit including a cleavage group which generates a polar group by the action of acid is preferable, and examples thereof include “repeating unit having group represented by Expression (1)” and “repeating unit having group represented by Expression (2)” described in paragraphs 0065 to 0072 of WO2021/166619A, the description of which is incorporated herein by reference. Suitable specific examples of the repeating unit including a cleavage group which generates a polar group by the action of acid include the following examples.

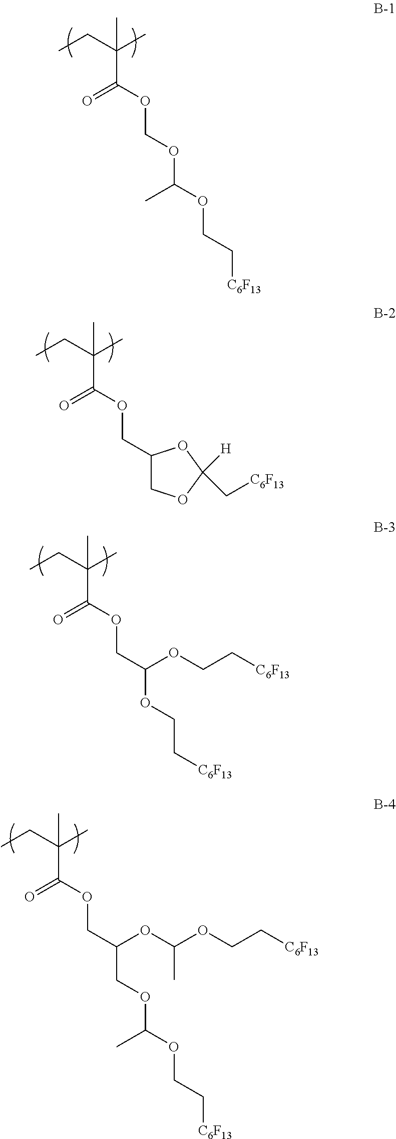

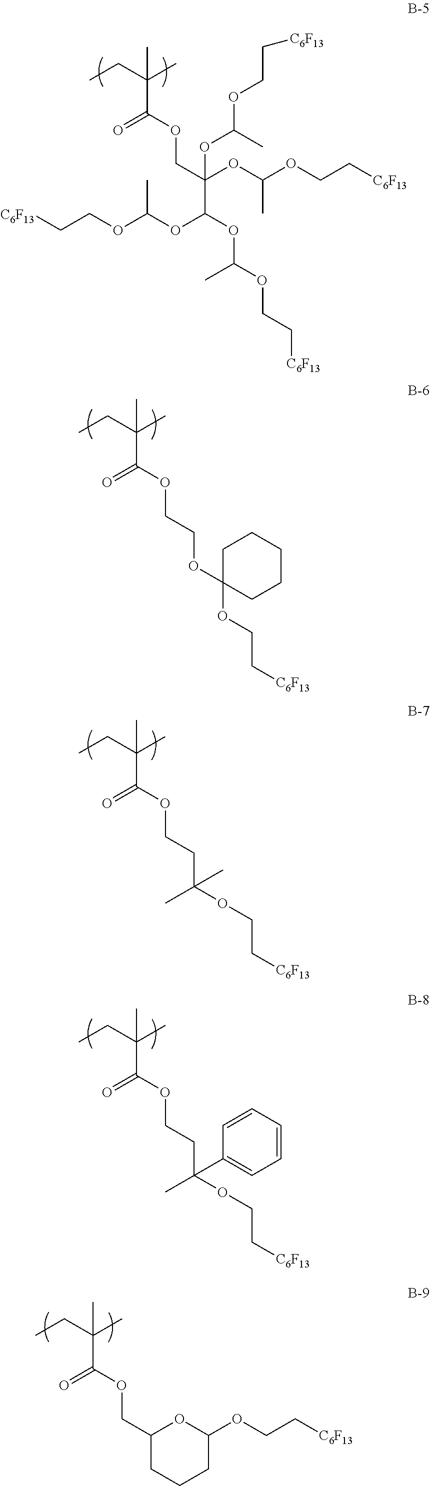

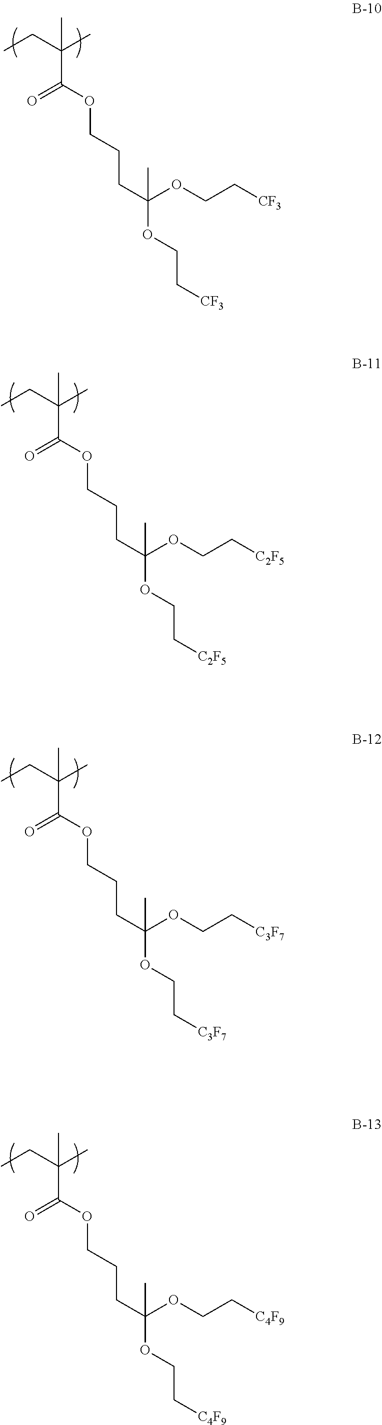

### (Repeating Unit Containing Photo-Aligned Group)

In a case where the cleavage-type surfactant polymer has a repeating unit including a photo-alignment group, examples of the repeating unit including a photo-alignment group which may be included include a repeating unit represented by Formula (A) (hereinafter, also simply referred to as a “repeating unit A”).

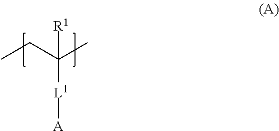

In Formula (A), R¹ represents a hydrogen atom or a substituent, L¹ represents a divalent linking group, and A represents a photo-aligned group.

Next, the hydrogen atom or the substituent represented by R¹ in Formula (A) will be described.

In Formula (A), as the substituent represented as one aspect of R¹, a halogen atom, a linear alkyl group having 1 to 20 carbon atoms, a branched or cyclic alkyl group having 3 to 20 carbon atoms, a linear halogenated alkyl group having 1 to 20 carbon atoms, an alkoxy group having 1 to 20 carbon atoms, an aryl group having 6 to 20 carbon atoms, an aryloxy group having 6 to 20 carbon atoms, a cyano group, or an amino group is preferable.

Next, the divalent linking group represented by L¹ in Formula (A) will be described.

For the reason that the aligning properties of the liquid crystal layer B described later are improved, as the divalent linking group, a divalent linking group obtained by combining at least two or more groups selected from the group consisting of a linear alkylene group having 1 to 18 carbon atoms and optionally having a substituent, a branched or cyclic alkylene group having 3 to 18 carbon atoms, an arylene group having 6 to 12 carbon atoms and optionally having a substituent, an ether group (—O—), a carbonyl group (—C(═O)—), and an imino group (—NH—) optionally having a substituent is preferable.

Here, examples of the substituent which may be included in the alkylene group, the arylene group, and the imino group include a halogen atom, an alkyl group, an alkoxy group, an aryl group, an aryloxy group, a cyano group, a carboxy group, an alkoxycarbonyl group, and a hydroxyl group.

Examples of the halogen atom include a fluorine atom, a chlorine atom, a bromine atom, and an iodine atom. Among these, a fluorine atom and a chlorine atom are preferable.

In addition, the number of carbon atoms in the alkyl group is preferably 1 to 18, the number of carbon atoms in the alkoxy group is preferably 1 to 18, and the number of carbon atoms in the aryl group is preferably 6 to 12.

In the present invention, from the reason that the alignment property of the liquid crystal layer B to be described later is improved, L¹ in Formula (A) preferably represents a divalent linking group including a cycloalkane ring, and preferably represents a divalent linking group including a nitrogen atom and a cycloalkane ring.

In the suitable aspect, a part of carbon atoms constituting the cycloalkane ring may be substituted with a heteroatom selected from the group consisting of nitrogen, oxygen, and sulfur. In addition, in a case where a part of carbon atoms constituting the cycloalkane ring is substituted with a nitrogen atom, no nitrogen atom may be included separately from the cycloalkane ring.

Further, a cycloalkane ring having 6 or more carbon atoms is preferable as the cycloalkane ring, and specific examples thereof include a cyclohexane ring, a cycloheptane ring, a cyclooctane ring, a cyclododecane ring, and a cyclodocosane ring.

In addition, in the present invention, from the reason that the alignment property of the liquid crystal layer B to be described later is improved, L¹ in Formula (A) is preferably a divalent linking group represented by any of Formulae (3) to (12).

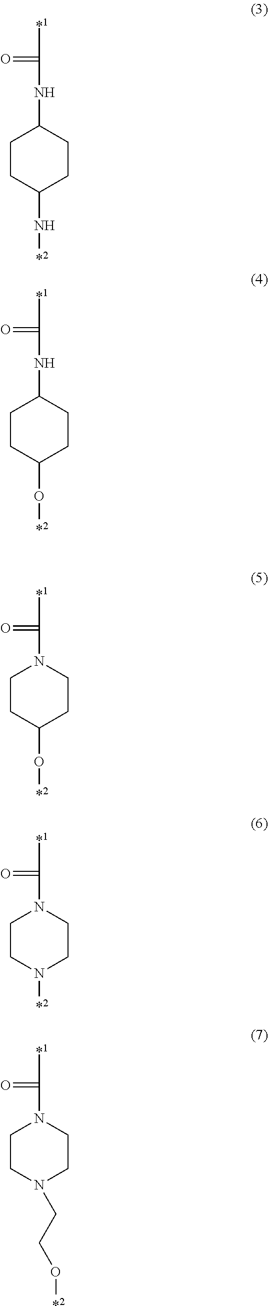

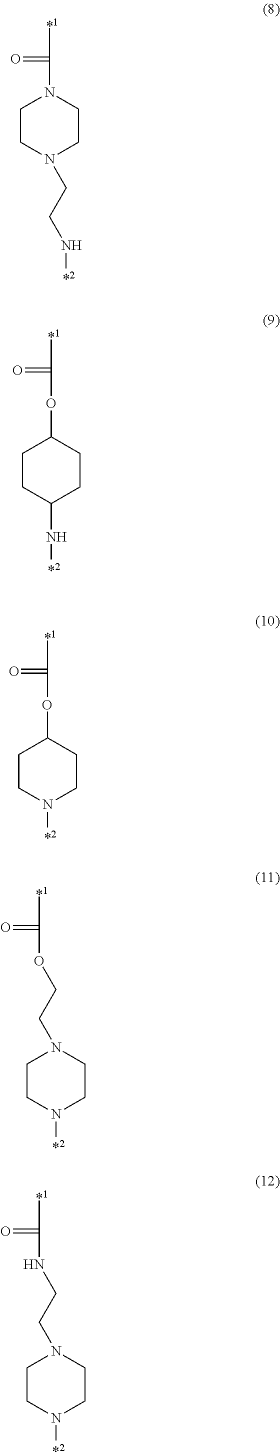

In Formulae (3) to (12), *1 represents a bonding position to a carbon atom to which R¹ in Formula (A) is bonded, and *2 represents a bonding position to A in Formula (A).

Among the divalent linking groups represented by any of Formulae (3) to (12), a divalent linking group represented by any of Formulae (4), (5), (9), and (10) is preferable from the viewpoint of enhancing the balance between the solubility in a solvent used for forming the optically anisotropic layer and the solvent resistance of the optically anisotropic layer to be obtained.

Next, the photo-aligned group represented by A in Formula (A) will be described.

From the reason that thermal stability and/or chemical stability of a monomer having the photo-aligned group is good, the photo-aligned group is preferably a group which undergoes at least one of dimerization or isomerization by action of light.

Suitable specific examples of the group which is dimerized by the action of light include groups having a skeleton of at least one derivative selected from the group consisting of a cinnamic acid derivative, a coumarin derivative, a chalcone derivative, a maleimide derivative, and a benzophenone derivative.

On the other hand, suitable specific examples of the group which is isomerized by the action of light include groups having a skeleton of at least one compound selected from the group consisting of an azobenzene compound, a stilbene compound, a spiropyran compound, a cinnamic acid compound, and a hydrazono-β-ketoester compound.

Among such photo-alignment groups, groups having a skeleton of at least one derivative or compound selected from the group consisting of a cinnamic acid derivative, a coumarin derivative, a chalcone derivative, a maleimide derivative, an azobenzene compound, a stilbene compound, and a spiropyran compound are preferable. Among these, for the reason that the aligning properties of the liquid crystal layer B described later are improved, groups having a skeleton of a cinnamic acid derivative or an azobenzene compound are more preferable, and groups having a skeleton of a cinnamic acid derivative (hereinafter, also abbreviated as “cinnamoyl group”) are even more preferable.

In the present invention, as the photo-alignment group, photo-alignment groups described in paragraphs [0036] to [0040] of WO2020/179864A are preferable.

In addition, examples of the repeating unit A represented by Formula (A) include repeating units described in paragraphs [0041] to [0049] of WO2020/179864A.

### (Repeating Unit B)

The cleavage-type surfactant polymer may have a repeating unit having a polymerizable group (hereinafter, also referred to as a “repeating unit B”) in addition to the repeating unit including a cleavage group and the repeating unit including a photo-alignment group described above.

Examples of the repeating unit B include repeating units B described in paragraphs 0050 to 0055 of WO2020/179864A, the description of which is incorporated herein by reference.

A content of the repeating unit including a cleavage group in the cleavage-type surfactant polymer is not particularly limited, and from the reason that the alignment property of the liquid crystal layer B to be described later is improved, the content is preferably 1% by mole or more, more preferably 10% by mole or more, and still more preferably 20% by mole or more with respect to all repeating units of the cleavage-type surfactant polymer.

It is preferable that the cleavage-type surfactant polymer contains a repeating unit other than the repeating unit including a cleavage group. In this case, a content of the repeating unit including a cleavage group in all repeating units of the cleavage-type surfactant polymer is preferably 1% to 70% by mole, more preferably 10% to 60% by mole, and still more preferably 20% to 50% by mole.

In a case where the cleavage-type surfactant polymer contains a repeating unit including a photo-alignment group, a content of the repeating unit including a photo-alignment group in the cleavage-type surfactant polymer is not particularly limited, and from the reason that the alignment property of the liquid crystal layer B to be described later is improved, the content is preferably 5% to 70% by mole, more preferably 10% to 60% by mole, and still more preferably 15% to 50% by mole with respect to all repeating units of the cleavage-type surfactant polymer.

In a case where the cleavage-type surfactant polymer contains a repeating unit B, a content of the repeating unit B in the cleavage-type surfactant polymer is not particularly limited, and for example, the content is preferably 20% to 99% by mole, more preferably 30% to 90% by mole, and still more preferably 40% to 70% by mole with respect to all repeating units of the cleavage-type surfactant polymer.

In addition, the cleavage-type surfactant polymer may have a repeating unit other than the above-described repeating unit.

Examples of a monomer (radically polymerizable monomer) forming other repeating units include an acrylic acid ester compound, a methacrylic acid ester compound, a maleimide compound, an acrylamide compound, acrylonitrile, maleic acid anhydride, a styrene compound, and a vinyl compound.

A method for synthesizing the cleavage-type surfactant polymer is not particularly limited, and for example, the cleavage-type surfactant polymer can be synthesized by mixing any monomer among a monomer constituting the repeating unit including a cleavage group, a monomer constituting the repeating unit including a photo-alignment group, a monomer constituting the repeating unit B, and a monomer constituting other repeating units, and polymerizing the mixture in an organic solvent using a radical polymerization initiator.

A weight-average molecular weight (Mw) of the cleavage-type surfactant polymer is not particularly limited, and is preferably 10000 to 500000, more preferably 10000 to 300000, and still more preferably 30000 to 150000.

Here, the weight-average molecular weight in the present invention is a value measured by gel permeation chromatography (GPC) under the following conditions.
Solvent (eluant): tetrahydrofuran (THF)
Device Name: TOSOH HLC-8320GPC
Column: Three items of TOSOH TSKgel Super HZM-H (4.6 mm×15 cm) are connected and used.
Column Temperature: 40° C.
Sample Concentration: 0.1% by mass
Flow Rate: 1.0 ml/min
Calibration curve: TSK standard polystyrene (manufactured by TOSOH Corporation), calibration curves of 7 samples with Mw of 2,800,000 to 1,050 (Mw/Mn=1.03 to 1.06) are used

### (Photo-Acid Generator)

It is preferable that the composition for forming an optically anisotropic layer contains a photoacid generator.

The photo-acid generator is not particularly limited, and is preferably a compound which is sensitive to actinic rays having a wavelength of 300 nm or more, preferably 300 to 450 nm, and generates an acid. A photo-acid generator which is not directly sensitive to actinic rays having a wavelength of 300 nm or more can also be preferably used in combination with a sensitizer as long as it is a compound which is sensitive to actinic rays having a wavelength of 300 nm or more and generates an acid by being used in combination with the sensitizer.

The photo-acid generator is preferably a photo-acid generator which generates an acid with a pKa of 4 or less, more preferably a photo-acid generator which generates an acid with a pKa of 3 or less, and even more preferably a photo-acid generator which generates an acid with a pKa of 2 or less. In the present invention, the pKa basically refers to a pKa in water at 25° C. With a compound which cannot be measured in water, the pKa refers to a pKa measured after changing to a solvent suitable for the measurement. Specifically, the pKa described in a chemical handbook or the like can be referred to. The acid with a pKa of 3 or less is preferably a sulfonic acid or a phosphonic acid, and more preferably a sulfonic acid.

Examples of the photo-acid generator include an onium salt compound, trichloromethyl-s-triazines, a sulfonium salt, an iodonium salt, quaternary ammonium salts, a diazomethane compound, an imidosulfonate compound, and an oxime sulfonate compound. Among these, an onium salt compound, an imidosulfonate compound, or an oxime sulfonate compound is preferable, and an onium salt compound or an oxime sulfonate compound is particularly preferable. The photo-acid generators can be used alone or in combination of two or more types thereof.

### (Polymerization Initiator)

The composition may include a polymerization initiator.

The type of the polymerization initiator is not particularly limited, and examples thereof include a photopolymerization initiator and a thermal polymerization initiator, and a photopolymerization initiator that can initiate a polymerization reaction by ultraviolet irradiation is preferable. The polymerization initiator may be any one of a radical polymerization initiator or a cationic polymerization initiator.

Examples of the photopolymerization initiator include α-carbonyl compounds (described in each of the specifications of U.S. Pat. Nos. 2,367,661A and 2,367,670A), acyloin ethers (described in the specification of U.S. Pat. No. 2,448,828A), α-hydrocarbon-substituted aromatic acyloin compounds (described in the specification of U.S. Pat. No. 2,722,512A), multinuclear quinone compounds (described in each of the specifications of U.S. Pat. Nos. 3,046,127A and 2,951,758A), combinations of a triarylimidazole dimer and a p-aminophenyl ketone (described in the specification of U.S. Pat. No. 3,549,367A), acridine and phenazine compounds (described in JP1985-105667A (JP-S60-105667A) and the specification of U.S. Pat. No. 4,239,850A), oxadiazole compounds (described in the specification of U.S. Pat. No. 4,212,970A), and acyl phosphine oxide compounds (described in JP1988-040799B (JP-S63-040799B), JP1993-029234B (JP-H05-029234B), JP1998-095788A (JP-H10-095788A), and JP1998-029997A (JP-H10-029997A)).

In a case where the composition contains a polymerization initiator, the content of the polymerization initiator is preferably 0.01 to 30 parts by mass, and more preferably 0.1 to 15 parts by mass with respect to 100 parts by mass in total of the coloring agent and the liquid crystal compound in the composition.

The polymerization initiators may be used alone or in combination of two or more. In a case where two or more polymerization initiators are used, the total amount thereof is preferably within the above range.

### (Solvent)

The composition preferably contains a solvent from the viewpoint of workability.

Examples of the solvent include ketones, ethers, aliphatic hydrocarbons (for example, hexane), alicyclic hydrocarbons, aromatic hydrocarbons, halogenated hydrocarbons, esters, alcohols, cellosolves, cellosolve acetates, sulfoxides, amides, organic solvents for heterocyclic compounds, and water.

In a case where the composition contains a solvent, a content of the solvent in the liquid crystal composition (total of all components) is preferably 80% to 99% by mass and more preferably 83% to 97% by mass.

The solvents may be used alone or in combination of two or more. In a case where two or more solvents are used, the total amount thereof is preferably within the above range.

A film thickness of the liquid crystal layer A can be, for example, 0.1 to 10 μm, and is preferably 0.5 to 5 μm and more preferably 1 to 5 μm.

The extraordinary refractive index ne(A) of the liquid crystal layer A can be, for example, 1.40 to 2.0, and is preferably 1.50 to 1.80 and more preferably 1.55 to 1.75. In addition, the ordinary light refractive index no(A) of the liquid crystal layer A can be, for example, 1.40 to 1.70, and is preferably 1.45 to 1.65 and more preferably 1.50 to 1.60.

### (Method for Forming Liquid Crystal Layer A)

A method for forming the liquid crystal layer A using the above-described composition (hereinafter, also referred to as a “composition for forming liquid crystal layer A”) is not particularly limited, and examples thereof include a method including, in the following order, a step of applying the composition onto a predetermined substrate to form a coating film (hereinafter, also referred to as a “coating film forming step”), a step of aligning a liquid crystal component contained in the coating film (hereinafter, also referred to as an “alignment step”), and a step of performing a curing treatment on the coating film (hereinafter, also referred to as a “curing step”).

In a case where the above-described dichroic coloring agent has liquid crystallinity, the liquid crystalline component is a component which also includes the dichroic coloring agent having liquid crystallinity, in addition to the above-described liquid crystal compound.

Hereinafter, each of the above-described steps will be described in detail.

The coating film forming step is a step of applying a composition onto a predetermined substrate to form a coating film.

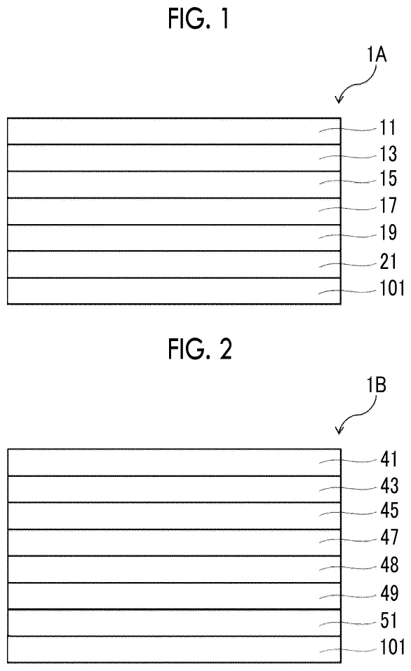

The kind of the substrate is not particularly limited, and examples of the substrate include a transparent support and a laminate in which an alignment film is disposed on a transparent support. The substrate may be directly incorporated into the display device according to the embodiment of the present invention, and may be incorporated as substrates 19 and 49 in FIGS. 1 and 2, for example.

Examples of the material for forming the transparent support include polycarbonate-based polymers; polyester-based polymers such as polyethylene terephthalate (PET) and polyethylene naphthalate; acrylic polymers such as polymethylmethacrylate; styrene-based polymers such as polystyrene and acrylonitrile-styrene copolymers (AS resins); polyolefin-based polymers such as polyethylene, polypropylene, and ethylene-propylene copolymers; vinyl chloride-based polymers; amide-based polymers such as nylon and aromatic polyamides; imide-based polymers; sulfone-based polymers; polyether sulfone-based polymers; polyether ether ketone-based polymers; polyphenylene sulfide-based polymers; vinylidene chloride-based polymers; vinyl alcohol-based polymers; vinyl butyral-based polymers; arylate-based polymers; polyoxymethylene-based polymers; and epoxy-based polymers.

Thermoplastic norbornene-based resins are also preferable as a material for forming the transparent support. Examples of the thermoplastic norbornene-based resin include Zeonex and Zeonor manufactured by Zeon Corporation, and ARTON manufactured by JSR Corporation.

In addition, cellulose-based polymers typified by triacetyl cellulose (TAC) are also preferable as a material for forming the transparent support.

These transparent supports may be subjected to a hydrophilization treatment by any of a glow discharge treatment, a corona discharge treatment, an alkali saponification treatment, or the like.

The thickness of the transparent support is not particularly limited, and is preferably 100 μm or less, more preferably 80 μm or less, and even more preferably 10 to 80 μm.

In the present invention, the term “transparent” denotes that the transmittance of visible light is 60% or greater, preferably 80% or greater, and more preferably 90% or greater.

The alignment film generally contains a polymer as a main component. The polymer for an alignment film is described in many documents, and many commercially available products thereof can be obtained, and these can be used without particular limitation. The polymer to be used is preferably polyvinyl alcohol (PVA), polyimide, or a derivative thereof.

The alignment film is preferably a film subjected to a known rubbing treatment.

In addition, a photo-alignment film may be used as the alignment film. The photo-alignment film can be produced by irradiating a photo-alignment compound with linearly polarized light or unpolarized light. For the photo-alignment treatment for forming the photo-alignment film, the description related to the photo-alignment treatment described later can be applied. The photo-alignment compound is preferably a photosensitive compound having a photoreactive group that undergoes at least one of dimerization or isomerization by the action of light. In addition, the photoreactive group preferably has a skeleton of at least one derivative or compound selected from the group consisting of a cinnamic acid derivative, a coumarin derivative, a chalcone derivative, a maleimide derivative, an azobenzene compound, a polyimide compound, a stilbene compound, and a spiropyran compound.

A thickness of the alignment film is preferably 0.01 to 10 μm.

In the above description, a laminate including a transparent support and an alignment film has been described as the substrate, but substrate is not limited to this form. For example, a transparent support having a surface subjected to a rubbing treatment may be used.

Examples of the method of applying the composition include a roll coating method, a gravure printing method, a spin coating method, a wire bar coating method, an extrusion coating method, a direct gravure coating method, a reverse gravure coating method, a die-coating method, a spray method, and an inkjet method.

The alignment step is a step of aligning a liquid crystalline component contained in the coating film.

The alignment step may include a drying treatment. By the drying treatment, a component such as a solvent can be removed from the coating film. The drying treatment may be performed by a method of allowing the coating film to stand at room temperature (20° C. to 25° C.) for a predetermined time (for example, natural drying), or may be performed by a method of heating and/or blowing air.

Here, the liquid crystalline component contained in the composition may be aligned by the coating film formation step or the drying treatment described above.

In a case where the drying treatment is performed at a temperature higher than or equal to a transition temperature of the liquid crystalline component contained in the coating film to the liquid crystal phase, a heat treatment described below may not be performed.

The transition temperature of the liquid crystalline component contained in the coating film to the liquid crystal phase is preferably 10° C. to 250° C., and more preferably 25° C. to 190° C. from the viewpoint of production suitability and the like.

It is preferable that the alignment step includes a heat treatment. Thereby, the liquid crystal component contained in the coating film can be aligned.

The heating temperature during the heating treatment is preferably 10° C. to 250° C., and more preferably 25° C. to 190° C. from the viewpoint of production suitability and the like. The heating time is preferably 1 to 300 seconds, and more preferably 1 to 90 seconds.

The alignment step may include a cooling treatment performed after the heat treatment. The cooling treatment is a treatment of cooling the heated coating film to room temperature (20° C. to 25° C.). Thereby, the alignment of the liquid crystalline component contained in the coating film can be fixed. A cooling unit is not particularly limited, and the cooling treatment can be performed according to a known method.

The curing step is performed by, for example, heating the coating film and/or irradiating (exposing) the coating film with light. Among these, it is preferable that the curing step is performed by irradiating the coating film with light. By the light irradiation, as described above, an acid is generated from the photoacid generator (hereinafter, also referred to as an “acid generation step”), the cleavage-type surfactant polymer is cracked and eliminated by the acid generated in the elimination part, and a liquid crystal layer B exhibiting alignment properties can be directly formed on the liquid crystal layer A.

Examples of the light to be used for curing include infrared rays, visible light, and ultraviolet rays, and ultraviolet rays are preferable. Ultraviolet rays may be applied while heating is performed during curing, or applied via a filter which transmits only light of a specific wavelength.

An exposure amount during the light irradiation is not particularly limited, but is preferably 10 to 2000 mJ/cm², and more preferably 200 to 1000 mJ/cm² from the viewpoint that the durability of the liquid crystal layer A is more excellent.

In a case where exposure is performed during heating, the heating temperature during the exposure is preferably 25° C. to 140° C.

In addition, the exposure may be performed under a nitrogen atmosphere.

The curing step and the acid generation step may be performed in the following order, or may be performed simultaneously: the curing step is performed, and then the acid generation step is performed. In particular, in a case where the photo-acid generator and the polymerization initiator in the composition are exposed to light of the same wavelength, it is preferable that the curing treatment and the acid generation treatment are performed at the same time from the viewpoint of productivity.

A photo-alignment film may be formed on the surface of the liquid crystal layer A obtained as described above by irradiating the surface with non-polarized light from an oblique direction with respect to the polarized light or the surface of the liquid crystal layer A.

In the photo-alignment treatment, the polarized light to be irradiated is not particularly limited, and examples thereof include linearly polarized light, circularly polarized light, and elliptically polarized light, and linearly polarized light is preferable.

In addition, the “oblique direction” in which irradiation with unpolarized light is performed is not particularly limited as long as it is a direction inclined at a polar angle θ (0°<0<) 90° with respect to a normal direction of the liquid crystal layer A. 0 can be appropriately selected according to the purpose, and is preferably 20° to 80°.

A wavelength of the polarized light or the unpolarized light is not particularly limited as long as the light is light to which the photo-aligned group is exposed. Examples thereof include ultraviolet (UV) rays, near-ultraviolet rays, and visible rays, and near-ultraviolet rays of 250 to 450 nm are preferable.

In addition, examples of a light source for the irradiation with polarized light or unpolarized light include a xenon lamp, a high-pressure mercury lamp, an ultra-high pressure mercury lamp, and a metal halide lamp. By using an interference filter, a color filter, or the like with respect to ultraviolet rays or visible rays obtained from the light source, the wavelength range of the irradiation can be restricted. In addition, linearly polarized light can be obtained by using a polarization filter or a polarization prism with respect to the light from the light source.

An integrated quantity of the polarized light or the unpolarized light is not particularly limited, and is preferably 1 to 300 mJ/cm² and more preferably 5 to 100 mJ/cm².

An illuminance of the polarized light or the unpolarized light is not particularly limited, and is preferably 0.1 to 300 mW/cm² and more preferably 1 to 100 mW/cm².

### [Liquid Crystal Layer B]

The liquid crystal layer B is formed of a composition containing a liquid crystal compound.

For the composition containing a liquid crystal compound (hereinafter, also referred to as a “composition for forming liquid crystal layer B”) used for forming the liquid crystal layer B, the description of the composition containing a coloring agent and a liquid crystal compound used for forming the liquid crystal layer A can be applied. The liquid crystal layer B may contain a coloring agent and a cleavage-type surfactant polymer as optional components, but preferably does not contain the coloring agent and the cleavage-type surfactant polymer.

The liquid crystal layer B is disposed adjacent to the liquid crystal layer A (that is, directly in contact with the liquid crystal layer A). Therefore, for the method for forming the liquid crystal layer B, the description related to the method for forming the liquid crystal layer A can be applied in the same manner as in the description related to the method for forming the liquid crystal layer A, except that “liquid crystal layer A” is used instead of “substrate” and “composition for forming liquid crystal layer B” is used instead of “composition for forming liquid crystal layer A”.

In a case where the liquid crystal layer A and the liquid crystal layer B are produced from the same composition or a composition having a similar liquid crystallinity, such as a composition containing the same liquid crystal compound, since Expression (1) is satisfied, it is preferable that the liquid crystal layer A and the liquid crystal layer B are produced to have the same alignment direction and each alignment degree satisfies Expression (3), and it is preferable that the liquid crystal layer A and the liquid crystal layer B are produced to satisfy Expression (3A). The alignment degree can be appropriately adjusted by a common method such as adjusting the alignment aging.

$$S ( A ) > S ( B ) \qquad Expression ( 3 )$$

$$S ( A ) > S ( B ) + 0.3 \qquad Expression ( 3 A )$$

In the expression, S(A) indicates the alignment degree of the liquid crystal layer A, and S(B) indicates the alignment degree of the liquid crystal layer B.

The alignment degree S(A) of the liquid crystal layer A can be set to 0.10 to 1.00, and is preferably 0.50 to 1.00 and more preferably 0.80 to 1.00. The alignment degree S(B) of the liquid crystal layer B can be set to 0.10 to 0.99, and is preferably 0.20 to 0.90 and more preferably 0.20 to 0.60.

A film thickness of the liquid crystal layer B can be, for example, 0.1 to 10 μm, and is preferably 0.3 to 5 μm and more preferably 0.5 to 3 μm.

The extraordinary refractive index ne(B) of the liquid crystal layer B can be, for example, 1.40 to 1.79, and is preferably 1.45 to 1.70 and more preferably 1.50 to 1.65. In addition, the ordinary refractive index no(B) of the liquid crystal layer B can be, for example, 1.40 to 1.70, and is preferably 1.45 to 1.65 and more preferably 1.50 to 1.60.

### [Adhesive Layer C]

It is also preferable that the laminate according to the embodiment of the present invention has the adhesive layer C on a side of the liquid crystal layer B opposite to a side in contact with the liquid crystal layer A.

The adhesive layer C can be formed of a layer consisting of a commonly used pressure-sensitive adhesive or an adhesive in a case of bonding the liquid crystal layer A to a film such as a surface film, without particular limitation. For example, a layer having the same function as the bonding layers D21 and D51 described later is preferably exemplified.

It is more preferable that the adhesive layer C is transparent and exhibits optical isotropy. In general, the refractive index n(C) of the adhesive layer C is 1.4 to 1.6.

As the pressure-sensitive adhesive used in the adhesive layer C, a pressure-sensitive adhesive which is transparent and exhibits optical isotropy is preferable, and examples thereof include an acrylic pressure-sensitive adhesive, and a pressure-sensitive adhesive is generally used.

In a case where the adhesive layer C is a layer consisting of a pressure-sensitive adhesive, an appropriate additive such as a conductive particle, a thermally expandable particle, a crosslinking agent (for example, an isocyanate-based crosslinking agent or an epoxy-based crosslinking agent), a pressure-sensitive adhesive agent (for example, a rosin derivative resin, a polyterpene resin, a petroleum resin, or an oil-soluble phenol resin), a plasticizer, a filler, an aging inhibitor, a surfactant, an ultraviolet absorber, a light stabilizer, and an antioxidant may be blended into the adhesive layer C in addition to the base material (pressure-sensitive adhesive).

Examples of the pressure-sensitive adhesive constituting the adhesive layer C include SK2057 (trade name, acrylic pressure-sensitive adhesive, manufactured by Soken Chemical & Engineering Co., Ltd.).

The adhesive used in the adhesive layer C is preferably an adhesive which is transparent and exhibits optical isotropy, and exhibits adhesiveness by drying and/or reaction after bonding.

A polyvinyl alcohol-based adhesive (PVA-based adhesive) exhibits adhesiveness due to drying, and is capable of bonding materials to each other.

Specific examples of the curable adhesive which exhibits adhesiveness due to reaction include an active energy ray-curable adhesive such as a (meth)acrylate-based adhesive and a cationic polymerization curable adhesive. The (meth)acrylate denotes acrylate and/or methacrylate. Examples of the curable component in the (meth)acrylate-based adhesive include a compound having a (meth)acryloyl group and a compound having a vinyl group. In addition, as the cationic polymerization-curable adhesive, a compound having an epoxy group, an oxetanyl group, or the like can also be used. The compound having an epoxy group is not particularly limited as long as it has at least two epoxy groups in the molecule, and various generally known curable epoxy compounds can be used. Preferable examples of the epoxy compound include a compound (aromatic epoxy compound) having at least two epoxy groups and at least one aromatic ring in the molecule and a compound (alicyclic epoxy compound) having at least two epoxy groups in the molecule, in which at least one of the epoxy groups is formed between two adjacent carbon atoms constituting an alicyclic ring.

Among these, from the viewpoint of heat deformation resistance, an ultraviolet curable adhesive which is cured by irradiation with ultraviolet rays is preferably used.

A film thickness of the adhesive layer C can be, for example, 0.1 to 50 μm, and is preferably 0.3 to 30 μm and more preferably 3 to 28 μm.

### [Surface Film]

It is also preferable that the laminate according to the embodiment of the present invention has the surface film on a side of the adhesive layer C opposite to a side in contact with the liquid crystal layer B.

The surface film can be used without particular limitation as a surface film commonly used in the display device, and for example, a film including (or containing as a main component) at least any of a cellulose ester resin, an acrylic resin, a cyclic olefin resin, or a polyethylene terephthalate resin can be preferably used. It is preferable that the surface film is a film exhibiting optical isotropy and having a refractive index n close to the refractive index n(C) of the adhesive layer C, and for example, Fujitac TG60UL (trade name, manufactured by FUJIFILM Corporation) is preferable.

A film thickness of the surface film can be, for example, 10 to 200 μm, and is preferably 15 to 120 μm and more preferably 20 to 100 μm.

In the laminate according to the embodiment of the present invention, it is preferable that the alignment directions of the liquid crystal layer A and the liquid crystal layer B are each in vertical alignment. In this case, the laminate according to the embodiment of the present invention can be suitably used as an antireflection film that suppresses external light reflection by transmitting light in the front direction and absorbing light in the oblique direction in the liquid crystal layer A.

The term “vertically aligned” means that the alignment direction of the liquid crystal layer is within a range of =10° with respect to the film thickness direction of each liquid crystal layer, and is preferably within a range of +5° and more preferably within a range of +3°.

In addition, the term “alignment direction of liquid crystal layer” means “alignment direction of liquid crystal compound constituting liquid crystal layer”. In the liquid crystal layer A, the term “alignment direction of liquid crystal compound constituting liquid crystal layer” is synonymous with an alignment direction of the coloring agent contained in the liquid crystal layer A.

As shown in FIG. 1, in a case of being incorporated into the display device 1A according to the embodiment of the present invention, the liquid crystal layer A that is vertically aligned is disposed as a vertically aligned coloring agent layer 17, and the liquid crystal layer B that is vertically aligned is disposed as a vertically aligned IM layer 15, such that, from the side closer to the display device P101, the vertically aligned coloring agent layer 17 and the vertically aligned IM layer 15 are arranged in this order, for example, via the bonding layer D21 and the substrate 19, with respect to the display device P101 having an image display function.

In addition, in the laminate according to the embodiment of the present invention, it is also preferable that the alignment directions of the liquid crystal layer A and the liquid crystal layer B are each in horizontal alignment. In this case, the laminate according to the embodiment of the present invention can be suitably used as a polarizing plate that functions as a linear polarizer which absorbs light in the x direction in which the liquid crystal layer A is present in the xy orthogonal axis in the horizontal direction and transmits light in the y direction.

The term “horizontally aligned” means that the alignment direction of the liquid crystal layer is within a range of +10° with respect to a plane perpendicular to the film thickness direction of each liquid crystal layer, and is preferably within a range of +5° and more preferably within a range of +3°.

As shown in FIG. 2, in a case of being incorporated into the display device 1B according to the embodiment of the present invention, the liquid crystal layer A that is horizontally aligned is disposed as a horizontally aligned coloring agent layer 47, and the liquid crystal layer B that is horizontally aligned is disposed as a horizontally aligned IM layer 45, such that, from the side closer to the display device P101, the horizontally aligned coloring agent layer 47 and the horizontally aligned IM layer 45 are arranged in this order, for example, via the bonding layer D51 and the substrate 49, with respect to the display device P101 having an image display function.

### [Display Device]

The display device according to the embodiment of the present invention includes the laminate according to the embodiment of the present invention.

The display device according to the embodiment of the present invention preferably has a configuration in which the laminate according to the embodiment of the present invention is provided on a front surface (viewer side) of the display device having an image display function. The display device according to the embodiment of the present invention can use a configuration of a display device commonly used as other configurations as long as the laminate according to the embodiment of the present invention is included, without particular limitation.

A method for manufacturing the display device according to the embodiment of the present invention is not particularly limited, and examples thereof include a method of laminating the laminate according to the embodiment of the present invention and the display device having an image display function. In addition, in a case of laminating both of the display device and the laminate according to the embodiment of the present invention, the bonding layer may be disposed between the self-luminous display element in the display device and the liquid crystal layer A in the laminate according to the embodiment of the present invention to bond both of the display device and the laminate according to the embodiment of the present invention.

For example, the display device 1A of FIG. 1 includes the laminate according to the embodiment of the present invention (the antireflection film according to the embodiment of the present invention) in which the substrate 19, the vertically aligned coloring agent layer 17, the vertically aligned IM (index matching) layer 15, the adhesive layer C13, and the surface film 11 are laminated in this order. The display device 1A of FIG. 1 has a configuration in which the substrate 19 in the laminate according to the embodiment of the present invention is bonded to the display device P101 having an image display function via the bonding layer D21. Although not shown in FIG. 1, an alignment film layer and/or a photo-alignment film may be provided between the substrate 19 and the vertically aligned coloring agent layer 17.

In addition, the display device 1B of FIG. 2 includes the laminate according to the embodiment of the present invention (the polarizing plate according to the embodiment of the present invention) in which the substrate 49, the photo-alignment film 48, the horizontally aligned coloring agent layer 47, the horizontally aligned IM (index matching) layer 45, the adhesive layer C43, and the surface film 41 are laminated in this order. The display device 1B of FIG. 2 has a configuration in which the substrate 49 in the laminate according to the embodiment of the present invention is bonded to the display device P101 having an image display function via the bonding layer D51. Although not shown in FIG. 2, an alignment film layer may be provided between the substrate 49 and the photo-alignment film 48.

As the bonding layers D21 and D51, various known materials can be used as long as they can bond the display device P101 having an image display function and the laminate according to the embodiment of the present invention. The sticking layer may be, for example, a layer (adhesive layer) formed of an adhesive which has fluidity in a state of being stuck, and is then solidified, a layer (pressure-sensitive adhesive layer) formed of a pressure-sensitive adhesive which is a soft gel-like (rubber-like) solid in a state of being stuck, and does not change its gel-like state thereafter, or a layer formed of a material having characteristics of both an adhesive and a pressure-sensitive adhesive. Specific examples of the sticking layer include an optically transparent adhesive, an optically transparent double-sided tape, and an ultraviolet curable resin.

The display device P101 having an image display function and the laminate according to the embodiment of the present invention may be laminated and held by a frame, a jig, or the like to constitute the display device 1A or 1B according to the embodiment of the present invention, instead of bonding the display device P101 having an image display function and the laminate according to the embodiment of the present invention using the bonding layers D21 and D51.

In the display device according to the embodiment of the present invention, examples of the display device P101 having an image display function include an organic electroluminescence display device (OLED display device), an inorganic electroluminescence display device, and a liquid crystal display device.

### [OLED Display Device]

As another configuration of the OLED display device according to the embodiment of the present invention, the configuration of the generally used OLED display device can be used without particular limitation, as long as the laminate according to the embodiment of the present invention is included. A configuration example of the OLED display device according to the embodiment of the present invention is not particularly limited, and examples thereof include a display device including, in order from a side opposite to an external light, glass, a layer including a thin film transistor (TFT), an OLED display element, a barrier film, a color filter, glass, a bonding layer, a liquid crystal layer A, a liquid crystal layer B, an adhesive layer C, and a surface film. In the above-described configuration, a laminate consisting of the bonding layer, the liquid crystal layer A, the liquid crystal layer B, the adhesive layer C, and the surface film can be used as, for example, the laminate according to the embodiment of the present invention.

The OLED display element has a configuration in which an anode electrode, a light emitting layer, and a cathode electrode are laminated in this order. In addition to the light emitting layer, a hole injection layer, a hole transport layer, an electron transport layer, an electron injection layer, and the like are included between the anode electrode and the cathode electrode. In addition, for example, the description in JP2014-132522A can also be referenced.

The OLED display element may be monochromatic blue as long as the OLED display element comprises a light emitting diode as a light source, or may use three primary colors of blue, green, and red.

In addition, as the color filter, in addition to a typical color filter, a color filter in which quantum dots are laminated can also be used.

A resin film can be used instead of the above glass.

A method of forming a color image of the OLED that can be applied to the OLED display device according to the embodiment of the present invention can use any of a three-color coloring method of R (red), G (green), and B (blue), a color conversion method using quantum dots (QD), or a color filter method.

In addition, as the OLED display element, a display element in which quantum dots (QD) and OLED are combined, which is referred to as QD-OLED or the like, can also be used, and examples thereof include a display element having a structure in which a blue OLED is used as a light source and red and green quantum dots and a color filter are used to emit red and green.

For the QD-OLED, for example, the description of JP2022-78975A can be referred to.

In addition, the laminate according to the embodiment of the present invention can be preferably used in a micro light emitting diode (micro LED) display device and a mini light emitting diode (mini LED) display device. The mini LED means an LED having a chip size of about 100 to 200 μm square, and the micro LED means an LED having a chip size of less than 100 μm square. Preferred examples of the micro LED include the micro LED described in WO2014/204694A.

### [Inorganic Electroluminescent Display Device]

As another configuration of the inorganic EL display device according to the embodiment of the present invention, a configuration of a generally used inorganic EL display device can be used without particular limitation as long as the laminate according to the embodiment of the present invention is included. For example, the descriptions regarding the inorganic EL element and the inorganic electroluminescent display device, which are described in JP2005-338640A can be preferably applied.

### [Liquid Crystal Display Device]

As the liquid crystal display device according to the embodiment of the present invention, a configuration of a liquid crystal display device commonly used can be used as other configurations as long as the laminate according to the embodiment of the present invention is included, without particular limitation, and for example, an in-plane switching (IPS) mode liquid crystal display device described in paragraphs 0128 to 0136 of JP2010-102296A is preferable as the liquid crystal display device according to the embodiment of the present invention, except that the laminate according to the embodiment of the present invention is used.

### EXAMPLES

Hereinafter, the invention will be described in greater detail with examples. The materials, using amount, ratio, details of treatment, procedures of treatment, and the like described in Examples below can be appropriately changed without departing from the spirit of the present invention. Therefore, it is to be understood that the scope of the present invention is not limited to Examples described below. The room temperature means 25° C.

### Example 1: Antireflection Film

### (1) Formation of Alignment Film Layer

The following composition 1 for forming an alignment film was applied onto a surface of a commercially available cellulose acylate film (manufactured by FUJIFILM Corporation, trade name: FUJITAC TG60UL) using a wire bar. The support on which the coating film was formed was dried with hot air at 140° C. for 120 seconds to form an alignment film AL1, thereby obtaining a cellulose acylate film 1 with an alignment film. A film thickness of the alignment film AL1 was 1 μm.

Composition 1 for forming alignment film

| | | |
|---|---|---|
| Polymer PA-1 | 100.00 | parts by mass |
| Acid generator PAG-1 | 8.25 | parts by mass |
| Stabilizer DIPEA | 0.6 | parts by mass |
| Butyl acetate | 1001.42 | parts by mass |
| Methyl ethyl ketone | 250.36 | parts by mass |

Polymer PA-1: Polymer represented by the following formula. In the formula, the numerical value described in each repeating unit indicates a content ratio (unit: % by mass) of each repeating unit in all repeating units on a mass basis.

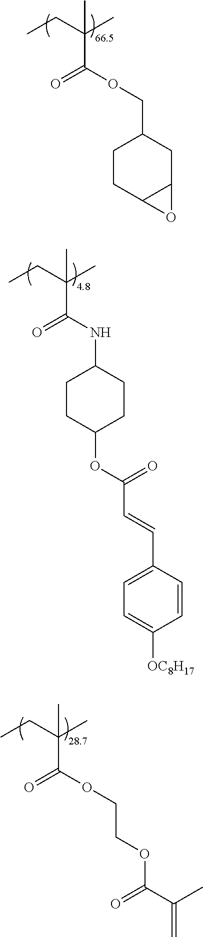

Acid generator PAG-1:

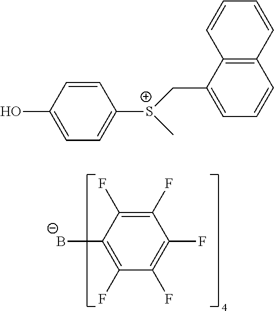

### Stabilizer DIPEA:

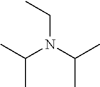

### (2) Formation of Vertically Aligned Coloring Agent Layer

The following composition A1 for forming a vertically aligned coloring agent layer was applied onto the alignment film AL1 of the obtained cellulose acylate film 1 with an alignment film using a bar coater to form a coating film. The coating film was dried at room temperature for 30 seconds, heated to 120° C., held for 60 seconds, and cooled to room temperature. Next, the coating film cooled to room temperature was heated at 85° C. for 60 seconds and cooled to room temperature again. Thereafter, the alignment was fixed by ultraviolet irradiation (exposure amount: 500 mJ/cm², LED lamp (central wavelength: 365 nm) was used), thereby forming a vertically aligned coloring agent layer. A film thickness of the vertically aligned coloring agent layer was 4.5 μm. Further, the F-part (fluorine-containing elimination part) of the F-part cleavage-type surfactant polymer F1 was cracked by heating at 130° C. for 1 minute.

Composition A1 for forming vertically aligned coloring agent layer

| | | |
|---|---|---|
| Polymerizable liquid crystal polymer P-1 | 8.67 | parts by mass |
| Dichroic coloring agent B1 | 0.69 | parts by mass |
| Dichroic coloring agent B2 | 0.17 | parts by mass |
| Dichroic coloring agent B3 | 1.13 | parts by mass |
| Vertical alignment agent E1 | 0.16 | parts by mass |
| Vertical alignment agent E2 | 0.16 | parts by mass |
| Polymerizable liquid crystal compound RA | 1.65 | parts by mass |
| Polymerizable liquid crystal compound RB | 0.28 | parts by mass |
| Polymerizable liquid crystal compound RC | 0.04 | parts by mass |
| Photoacid generator B-3 | 3.0 | parts by mass |
| IRGACURE OXE-02 (trade name, manufactured | 0.20 | parts by mass |
| by BASF) | | |
| F-part cleavage-type surfactant polymer F1 | 3.0 | parts by mass |
| Solvent (cyclopentanone) | 72.77 | parts by mass |
| Solvent (benzyl alcohol) | 8.09 | parts by mass |

Polymerizable liquid crystal polymer P-1: Polymer represented by the following formula. In the formula, the numerical value attached to each repeating unit indicates a content ratio (unit: % by mole) of each repeating unit in all repeating units. However, the numerical value attached to the ethyleneoxy group indicates the number of repetitions.

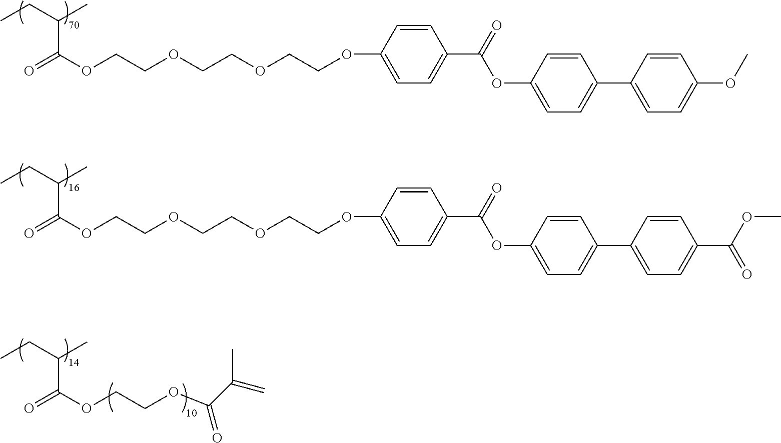

### Dichroic Coloring Agent B1:

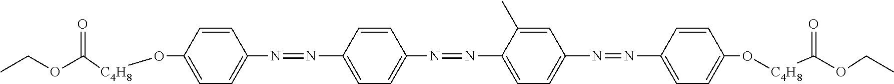

### Dichroic Coloring Agent B2:

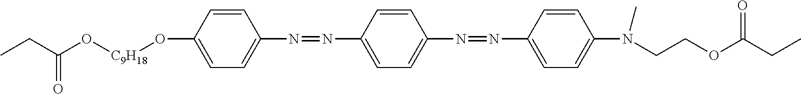

### Dichroic Coloring Agent B3:

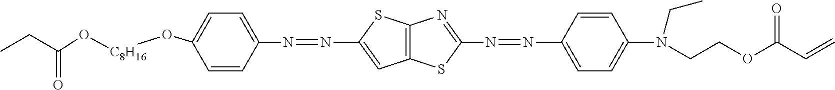

### Vertical Alignment Agent E1:

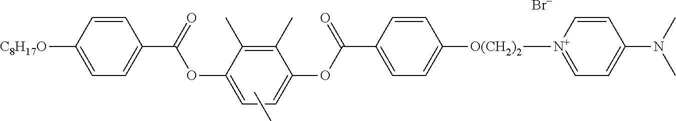

### Vertical Alignment Agent E2:

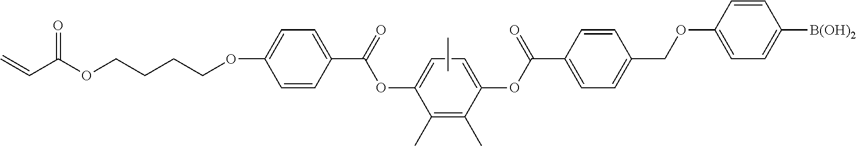

### Polymerizable Liquid Crystal Compound:

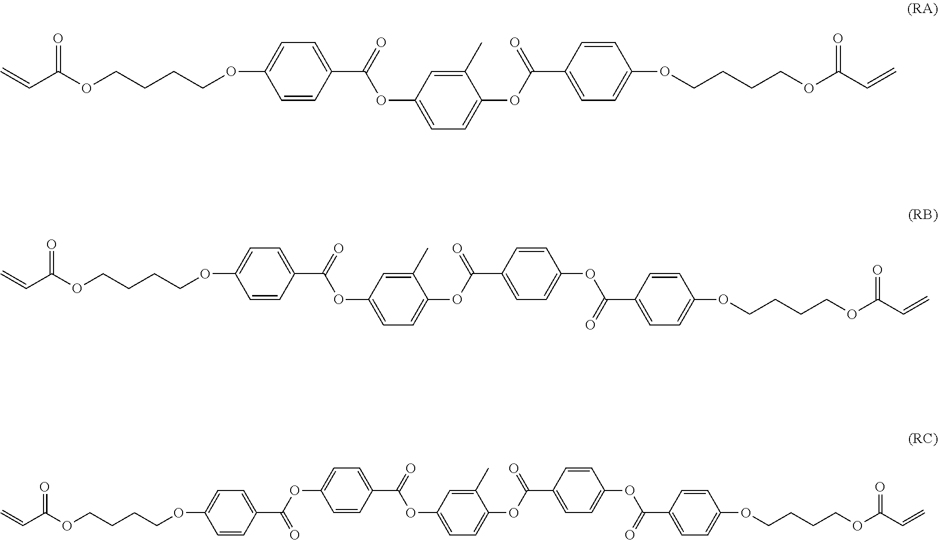

### Photoacid Generator B-3:

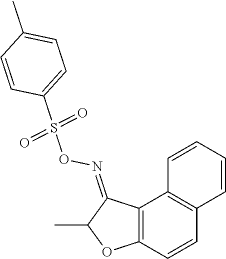 [SMILES: Cc1ccc(S(=O)(=O)O/N=C2/c3c(ccc4ccccc34)OC2C)cc1]

F-part cleavage-type surfactant polymer F1: Polymer represented by the following formula. In the formula, the numerical value attached to each repeating unit indicates a content ratio (unit: % by mole) of each repeating unit in all repeating units.

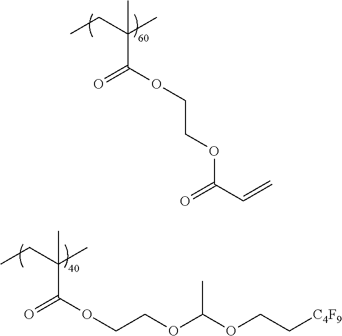

It is estimated that the repeating unit described on the right side in the repeating unit of the F-part cleavage-type surfactant polymer F1 is changed to the following repeating unit by cracking and elimination of the fluorine-containing elimination part by the acid generated from the photoacid generator.

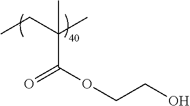

### (3) Formation of Vertically Aligned IM Layer

The following composition B1 for forming a vertically aligned IM layer was applied onto the obtained vertically aligned coloring agent layer using a bar coater to form a coating film. The coating film was dried at room temperature for 30 seconds, heated to 120° C., held for 20 seconds, and cooled to room temperature. Next, the coating film cooled to room temperature was irradiated with ultraviolet rays (exposure amount: 500 mJ/cm², ultra-high pressure mercury lamp was used) to fix the alignment, thereby producing a film No. 101 having a vertically aligned IM layer. A film thickness of the vertically aligned IM layer was 1.5 μm.

Composition B1 for forming vertically aligned IM layer

| | | |
|---|---|---|
| Polymerizable liquid crystal polymer P-1 | 8.67 | parts by mass |
| Vertical alignment agent E1 | 0.16 | parts by mass |
| Vertical alignment agent E2 | 0.16 | parts by mass |
| Polymerizable liquid crystal compound RA | 1.65 | parts by mass |
| Polymerizable liquid crystal compound RB | 0.28 | parts by mass |
| Polymerizable liquid crystal compound RC | 0.04 | parts by mass |
| IRGACURE OXE-02 (trade name, manufactured | 0.20 | parts by mass |
| by BASF) | | |
| Solvent (cyclopentanone) | 79.96 | parts by mass |
| Solvent (benzyl alcohol) | 8.88 | parts by mass |

The details of each component in the composition B1 for forming a vertically aligned IM layer are as described above.

### [4] Production of Laminate

The film No. 101 having a vertically aligned IM layer was bonded to the non-antireflection (AR) surface side of an AR film DSG-17 (trade name, manufactured by Dainippon Printing Co., Ltd.) using a pressure-sensitive adhesive sheet (trade name: SK2057, manufactured by Soken Chemical & Engineering Co., Ltd.) as a pressure-sensitive adhesive layer 1 (adhesive layer C), and the same pressure-sensitive adhesive sheet as the pressure-sensitive adhesive layer 1 was further bonded to the support side (side opposite to the vertically aligned IM layer) of the film No. 101 as a pressure-sensitive adhesive layer 2, thereby producing a laminate No. 101.

In the production of the laminate No. 101, the heating temperature in the formation of the vertically aligned IM layer was changed to 120° C., and the temperature was cooled to room temperature and further heated at 100° C. for 60 seconds, and the alignment degree of the vertically aligned IM layer was changed, and otherwise, the laminate No. 102 was produced in the same manner.

In addition, the laminate No. c11 was produced in the same manner as in the production of the laminate No. 101, except that the vertically aligned IM layer was not provided.

The laminates No. 101 and 102 are the laminates according to the embodiment of the present invention, and the laminate No. c11 is a comparative laminate.

### Example 2: Linearly Polarized Light Film

### (1) Formation of Alignment Film Layer

The alignment film AL1 side of the cellulose acylate film 1 with an alignment film produced in Example 1 was irradiated with polarized ultraviolet rays (10 mJ/cm², ultra-high pressure mercury lamp was used) in a direction of 45° with respect to the longitudinal direction using a wire grid type polarizer, thereby forming a photo-alignment layer PA1, thereby obtaining a cellulose acylate film PA1 with a photo-alignment layer.

### (2) Formation of Horizontally Aligned Coloring Agent Layer

The following composition A2 for forming a horizontally aligned coloring agent layer was applied onto the photo-alignment layer PA1 of the obtained cellulose acylate film PA1 with a photo-alignment layer using a bar coater to form a coating film. The coating film was dried at room temperature for 30 seconds, heated to 140° C., held for 20 seconds, and cooled to room temperature. Next, the coating film was heated at 90° C. for 60 seconds and cooled to room temperature again. The coating film cooled to room temperature was irradiated with ultraviolet rays (exposure amount: 500 mJ/cm², LED lamp (central wavelength: 365 nm) was used) to fix the alignment, thereby forming a horizontally aligned coloring agent layer. A film thickness of the horizontally aligned coloring agent layer was 1.5 μm.

Composition A2 for forming horizontally
aligned coloring agent layer

| | | |
|---|---|---|
| Polymerizable liquid crystal polymer P-1 | 3.58 | parts by mass |
| Dichroic coloring agent B1 | 0.36 | parts by mass |
| Dichroic coloring agent B2 | 0.53 | parts by mass |
| Dichroic coloring agent B3 | 0.31 | parts by mass |
| Polymerizable liquid crystal compound RA | 1.65 | parts by mass |
| Polymerizable liquid crystal compound RB | 0.28 | parts by mass |
| Polymerizable liquid crystal compound RC | 0.04 | parts by mass |
| Photoacid generator B-3 | 3.0 | parts by mass |
| IRGACURE OXE-02 (trade name, manufactured | 0.20 | parts by mass |
| by BASF) | | |
| F-part cleavage-type surfactant polymer F2 | 3.0 | parts by mass |
| Solvent (cyclopentanone) | 78.35 | parts by mass |
| Solvent (benzyl alcohol) | 8.71 | parts by mass |

F-part cleavage-type surfactant polymer F2: Polymer represented by the following formula. In the formula, the numerical value attached to each repeating unit indicates a content ratio (unit: % by mole) of each repeating unit in all repeating units.

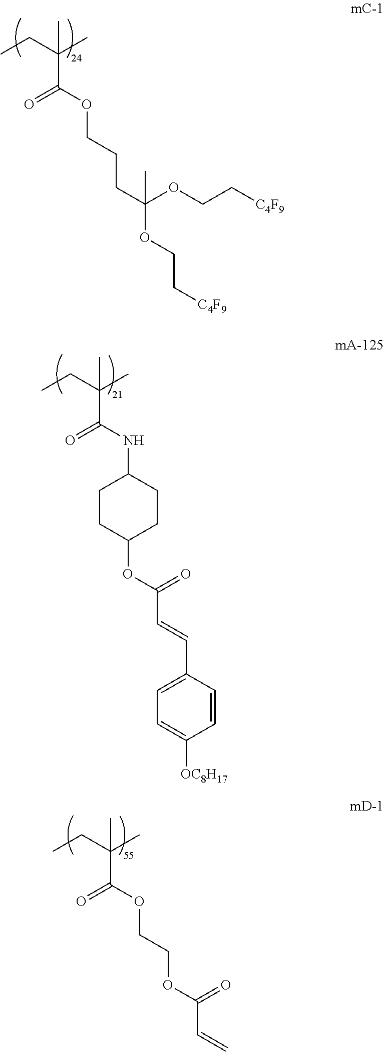

It is estimated that the repeating unit (mC-1) described on the left side in the repeating unit of the F-part cleavage-type surfactant polymer F2 is changed to the following repeating unit (C-1) by cracking and elimination of the fluorine-containing elimination part by the acid generated from the photoacid generator in the step (3).

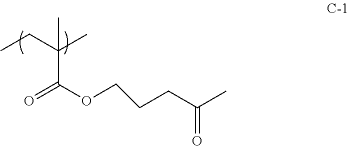

The details of each of the other components in the composition A2 for forming a horizontally aligned coloring agent layer are as described above.

### (3) Formation of Horizontally Aligned IM Layer

The obtained horizontally aligned coloring agent layer was heated at 130° C. for 1 minute to crack the F-part (fluorine-containing elimination part) of the F-part cleavage-type surfactant polymer F2. Thereafter, the temperature was lowered to room temperature, and the horizontally aligned coloring agent layer side was irradiated with UV light (ultra-high pressure mercury lamp; UL750; manufactured by HOYA Corporation) polarized in a direction of 45° with respect to the longitudinal direction at 7.9 mJ/cm² (wavelength: 313 nm) using a wire grid type polarizer, thereby performing a photo-alignment treatment. The following composition B2 for forming a horizontally aligned IM layer was applied onto the side on which the photo-alignment treatment was performed using a bar coater to form a coating film. The coating film was dried at room temperature for 30 seconds, heated to 120° C., held for 20 seconds, and cooled to room temperature. Next, the coating film cooled to room temperature was irradiated with ultraviolet rays (exposure amount: 500 mJ/cm², ultra-high pressure mercury lamp was used) to fix the alignment, thereby producing a film No. 201 having a horizontally aligned IM layer. A film thickness of the horizontally aligned IM layer was 1.5 μm.

Composition B2 for forming horizontally aligned IM layer

| | | |
|---|---|---|
| Polymerizable liquid crystal polymer P-1 | 8.67 | parts by mass |
| Polymerizable liquid crystal compound RA | 1.65 | parts by mass |
| Polymerizable liquid crystal compound RB | 0.28 | parts by mass |
| Polymerizable liquid crystal compound RC | 0.04 | parts by mass |
| IRGACURE OXE-02 (trade name, manufactured | 0.20 | parts by mass |
| by BASF) | | |
| Solvent (cyclopentanone) | 84.83 | parts by mass |
| Solvent (benzyl alcohol) | 9.43 | parts by mass |

The details of each of the other components in the composition B2 for forming a horizontally aligned IM layer are as described above.

### [4] Production of Laminate

In the production of the laminate No. 101 of Example 1, the film No. 201 having a horizontally aligned IM layer was used instead of the film No. 101 having a vertically aligned IM layer, and the AR film DSG-17 (trade name, manufactured by Dainippon Printing Co., Ltd.) was bonded to the horizontally aligned IM layer side using the pressure-sensitive adhesive layer 1 (adhesive layer C), and otherwise, the laminate No. 201 was produced in the same manner as in the laminate No. 101 of Example 1.

In the production of the laminate No. 201, the heating temperature in the formation of the horizontally aligned IM layer was changed to 120° C., and the temperature was cooled to room temperature and further heated at 100° C. for 60 seconds, and the alignment degree of the horizontally aligned IM layer was changed, and otherwise, the laminate No. 202 was produced in the same manner.

In addition, the laminate No. c21 was produced in the same manner as in the production of the laminate No. 201, except that the horizontally aligned IM layer was not provided.

The laminates No. 201 and 202 are the laminates according to the embodiment of the present invention, and the laminate No. c21 is a comparative laminate.

### <Evaluation>

The following evaluations were performed on the laminates Nos. 101 to 102, 201 to 202, c11, and c21 produced above. The results are summarized in Table 1 below.

### (Measurement of Extraordinary Refractive Index Ne and Ordinary Light Refractive Index No)

The extraordinary refractive index ne(A) and the ordinary refractive index no(A) of the vertically or horizontally aligned coloring agent layer and the extraordinary refractive index ne(B) and the ordinary refractive index no(B) of the vertically or horizontally aligned IM layer in each of the laminates produced above were measured and determined as follows.

The refractive index of the vertically or horizontally aligned coloring agent layer and the vertically or horizontally aligned IM layer in each of the laminates produced above was measured at 25° C. using a spectroscopic ellipsometer M-2000U or RC2 manufactured by J. A. Woollam Co., Ltd. or a spectroscopic ellipsometer SE-2000 manufactured by Semilab, Inc. (all of which are trade names).

Specifically, at 550 nm, a direction in which the in-plane refractive index is maximized was defined as an x-axis, a direction orthogonal to the x-axis in the plane was defined as a y-axis, a normal direction with respect to the plane was defined as a z-axis, the refractive index in the x-axis direction was defined as Nx550, the refractive index in the y-axis direction was defined as Ny550, and the refractive index in the z-axis direction was defined as Nz550.

In a case of vertical alignment, Nz550 is the extraordinary refractive index ne, and Nx550 and Ny550 usually have the same value, and these are the ordinary light refractive index no.

In a case of horizontal alignment, Nx550 is the extraordinary refractive index ne, and Ny550 and Nz550 usually have the same value, and these are the ordinary light refractive index no.

### (Measurement of Refractive Index n)

The refractive index n(C) of the adhesive layer C in each of the laminates produced above was measured at 25° C. using an Abbe refractometer (NAR-4T, manufactured by Atago Co., Ltd.) with a sodium lamp (2=589 nm) as a light source.

### (Measurement of Alignment Degree S(A))

The alignment degree S(A) of the vertically or horizontally aligned coloring agent layer was measured and calculated as follows from the angle dependence of the absorbance.

### (Measurement of Alignment Degree of Vertically Aligned Coloring Agent Layer)

The alignment degree of the vertically aligned coloring agent layer was adopted as a value measured and calculated by the following method.

Specifically, the Mueller matrix was measured at polar angles in a range of −70° to 70° at intervals of 5° in the in-plane slow axis direction using AxoScan (trade name, manufactured by Axometrics, Inc.), and kx(λ), ky(λ), and kz(λ) were obtained by fitting.

Next, the absorption anisotropies Ao(λ) and Ae(λ) were obtained according to the following equations (A) to (D), and the alignment degree S was calculated according to the following equation (E).

$$To ( λ ) = EXP \{ - 4 \times π \times ( ( kx ( λ ) + ky ( λ ) ) / 2 ) > d / λ \} \qquad ( A )$$

$$Te ( λ ) = EXP \{ - 4 \times π \times kz ( λ ) \times d / λ \} \qquad ( B )$$

$$Ao ( λ ) = - log ( To ( λ ) ) \qquad ( C )$$

$$Ae ( λ = - log ( Te ( λ ) ) \qquad ( D )$$

$$Alignment degree S ( λ ) = [ ( Ao ( λ ) / Ae ( λ ) ) - 1 ] / [ ( Ao ( λ ) / Ae ( λ ) ) + 2 ] \qquad ( E )$$

Here, d represents a film thickness (nm) of the vertically aligned coloring agent layer, To(λ) represents a transmittance in a direction having the highest transmittance at a wavelength λ, Te(λ) represents a transmittance in a direction having the lowest transmittance orthogonal to To(λ) at the wavelength λ, Ao(λ) represents a value obtained by converting To(λ) into an absorbance, and Ae(λ) represents a value obtained by converting Te(λ) into an absorbance. In a case of vertical alignment, To(λ) is usually a transmittance in a direction perpendicular to the sample surface, and Te(λ) is a transmittance in a direction parallel to the sample surface.

### (Measurement of Alignment Degree of Horizontally Aligned Coloring Agent Layer)

The alignment degree S was calculated by the following expression in a state where a linear polarizer was inserted on the light source side of an optical microscope (manufactured by Nikon Corporation, product name “ECLIPSE E600 POL”), the laminate was set on a sample stage, and the absorbance of the laminate was measured using a multi-channel spectrometer (manufactured by Ocean Optics, Inc., product name “QE65000”).

$$Alignment degree S = [ ( Az 0 / Ay 0 ) - 1 ] / [ ( Az 0 / Ay 0 ) + 2 ]$$

In the expression, Az0 represents an absorbance with respect to polarization in the absorption axis direction of the horizontally aligned coloring agent layer, and Ay0 represents an absorbance with respect to polarization in the transmission axis direction of the horizontally aligned coloring agent layer.

### (Measurement of Alignment Degree S(B))

The alignment degree S(B) of the vertically or horizontally aligned IM layer was measured and calculated by Raman spectroscopic measurement. The Raman spectroscopic measurement was performed using nanofinder30 (trade name, manufactured by Tokyo Instruments Co., Ltd.) under conditions of an incident laser wavelength of 785 nm and an objective lens of 20 times. The alignment degree was calculated using a wave number derived from the liquid crystal structure of the IM layer. As a measurement sample, a film having an IM layer was used, which was obliquely cut at an angle of about 0.5° with respect to the film surface, and the measurement was performed on a portion corresponding to the IM layer in the cutting surface.

An angle between the direction of the sample and the polarization direction of the laser was defined as a sample azimuth angle β, and the sample was rotated from β of 0° to 180° to measure the Raman scattering. In this case, the direction of the analyzer was set parallel (I_{∥}(β)) and perpendicular (I_{⊥}(β)) to the polarization plane of the incident laser, and the polarization Raman spectrum was measured for each of these. Further, the measurement was also performed from a direction tilted by 45° and −45° with respect to the normal direction of the film surface.

The ratio of I_{∥}(β) to I_{⊥}(β) was obtained with respect to the sample azimuth angle β, and the alignment degree S(B) was obtained by least-squares fitting with a theoretical expression.

### (Suppression of Interface Reflection)

For the laminate produced above, the interface reflection in the front direction and the oblique direction (direction tilted by 60° from the normal direction with respect to the light emitting surface) was observed and evaluated by the following method.

As an evaluation display, XRJ-55A95K (trade name, OLED television manufactured by Sony Corporation) was used. The surface film of the display unit of XRJ-55A95K was peeled off, and the laminate was bonded by peeling off the laminated sheet of the pressure-sensitive adhesive layer 2 of the laminate on a portion where the glass surface was exposed.

White light was emitted from a 3-wavelength type fluorescent lamp (trade name: FL20SS·EX-N/18, manufactured by Mitsubishi Electric Corporation) as a light source in a direction tilted by 8° from the normal direction with respect to the light emitting surface, and the value of the reflected light measured in a direction tilted by 8° from the normal direction in the opposite direction to the light source using a spectroradiometer SR-UL1R (trade name, manufactured by TOPCON CORPORATION) was defined as the reflected light in the front direction. In addition, the values measured in the same manner as in the front direction, except that the angles from the normal direction of the light source and the spectroradiometer were set to 60°, were defined as the reflected light in the oblique direction. The obtained measurement value of Y was compared with the Y value (Y0) measured for a standard white plate, and the reflectivity was obtained by the following expression.

$$( Reflectivity ) = ( Y / Y 0 ) \times 100 [ \% ]$$

TABLE 1

| | Vertically aligned coloring agent | | | | | | | | | Suppression of | |
|---|---|---|---|---|---|---|---|---|---|---|---|
| | layer | | | | Vertically aligned IM layer | | | | Adhesive | interface reflection | |
| | Alignment | | ne | no | Alignment | | ne | no | layer C | Front | Oblique |
| No. | direction | S (A) | (A) | (A) | direction | S (B) | (B) | (B) | n (C) | direction | direction |
| 101 | Vertical | 0.97 | 1.65 | 1.55 | Vertical | 0.25 | 1.58 | 1.52 | 1.49 | 1.0% | 1.5% |
| 102 | Vertical | 0.97 | 1.65 | 1.55 | Vertical | 0.50 | 1.61 | 1.51 | 1.49 | 1.0% | 1.7% |
| c11 | Vertical | 0.97 | 1.65 | 1.55 | — | — | — | — | 1.49 | 1.1% | 2.4% |

| | Horizontally aligned coloring | | | | | | | | | Suppression of | |
|---|---|---|---|---|---|---|---|---|---|---|---|
| | agent layer | | | | Horizontally aligned IM layer | | | | Adhesive | interface reflection | |
| | Alignment | | ne | no | Alignment | | ne | no | layer C | Front | Oblique |
| No. | direction | S (A) | (A) | (A) | direction | S (B) | (B) | (B) | n (C) | direction | direction |
| 201 | Horizontal | 0.97 | 1.65 | 1.55 | Horizontal | 0.25 | 1.58 | 1.52 | 1.49 | 0.8% | 2.1% |
| 202 | Horizontal | 0.97 | 1.65 | 1.55 | Horizontal | 0.50 | 1.61 | 1.51 | 1.49 | 0.9% | 2.3% |
| c21 | Horizontal | 0.97 | 1.65 | 1.55 | — | — | — | — | 1.49 | 1.0% | 3.1% |

(Note in table)
ne(A), no(A), ne(B), no(B), n(C), S(A), and S(B) are values measured by the above-described method.
“—” means that the corresponding layer is not provided.

From the results in Table 1 above, the following facts can be seen.

The laminates Nos. c11 and c21 for comparison, which did not include the vertically or horizontally aligned IM layer corresponding to the liquid crystal layer B defined in the present invention and directly bonded the vertically or horizontally aligned coloring agent layer corresponding to the liquid crystal layer A defined in the present invention to the AR (Anti Reflection) film via the adhesive layer C, had interface reflection in the oblique direction.

On the other hand, the laminates Nos. 101 to 102 and 201 to 202 according to the embodiment of the present invention, in which the vertically or horizontally aligned IM layer corresponding to the liquid crystal layer B defined in the present invention and the adhesive layer C were laminated in this order on the vertically or horizontally aligned coloring agent layer corresponding to the liquid crystal layer A defined in the present invention from the vertically or horizontally aligned coloring agent layer side and bonded to the AR (Anti Reflection) film via the adhesive layer C, could suppress the interface reflection in both the front direction and the oblique direction.

### EXPLANATION OF REFERENCES

1A, 1B: display device
11: surface film
13: adhesive layer C
15: vertically aligned IM (index matching) layer
17: vertically aligned coloring agent layer
19: substrate
21: bonding layer D
41: surface film
43: adhesive layer C
45: horizontally aligned IM (index matching) layer
47: horizontally aligned coloring agent layer
48: photo-alignment film
49: substrate
51: bonding layer D
101: display device P

What is claimed is:

1. A laminate comprising:
a liquid crystal layer A containing a coloring agent; and
a liquid crystal layer B disposed adjacent to the liquid crystal layer A,
wherein an extraordinary refractive index ne(A) of the liquid crystal layer A and an extraordinary refractive index ne(B) of the liquid crystal layer B satisfy Expression (1),
$$ne ( A ) > neg ( B ) . \qquad Expression ( 1 )$$

2. The laminate according to claim 1,
wherein the coloring agent is a dichroic coloring agent.

3. The laminate according to claim 1, further comprising:
an adhesive layer on a side of the liquid crystal layer B opposite to a side in contact with the liquid crystal layer A,
wherein ne(B) and a refractive index n(C) of the adhesive layer satisfy Expression (2),
$$ne ( B ) > n ( C ) . \qquad Expression ( 2 )$$

4. The laminate according to claim 1,
wherein alignment directions of the liquid crystal layer A and the liquid crystal layer B are each in vertical alignment.

5. The laminate according to claim 1,
wherein alignment directions of the liquid crystal layer A and the liquid crystal layer B are each in horizontal alignment.

6. An antireflection film comprising:
the laminate according to claim 4.

7. A polarizing plate comprising:
the laminate according to claim 5.

8. A display device comprising:
the laminate according to claim 1.

9. A display device comprising:
the antireflection film according to claim 6.

10. A display device comprising:
the polarizing plate according to claim 7.
